(19) United States
(12) Patent Application Publication
(10) Pub. No.: US 2026/0045984 A1
(43) Pub. Date: Feb. 12, 2026

(54) ELECTRONIC DEVICE FOR CHANGING TRANSMISSION ANTENNA, AND OPERATING METHOD THEREOF

(71) Applicant: Samsung Electronics Co., Ltd., Suwon-si (KR)

(72) Inventors: Jaemoon CHA, Suwon-si (KR); Minjae AN, Suwon-si (KR); Seoksun YUN, Suwon-si (KR); Saenghee LEE, Suwon-si (KR); Seongju LEE, Suwon-si (KR)

(21) Appl. No.: 19/359,200

(22) Filed: Oct. 15, 2025

Related U.S. Application Data
(63) Continuation of application No. PCT/KR2024/005230, filed on Apr. 18, 2024.

(30) Foreign Application Priority Data
Apr. 21, 2023 (KR) 10-2023-0052792
May 25, 2023 (KR) 10-2023-0067574

(51) Int. Cl. H04B 7/06; H04W 4/80

(52) U.S. Cl. CPC H04B 7/0608; H04W 4/80

(57) ABSTRACT

An electronic device may include at least one communication processor and at least one short-range communication module. A first RF signal for cellular communication can be controlled to be provided to a first antenna. The at least one short-range communication module can be configured to control that a second RF signal for non-cellular communication is provided to a second antenna included in a first antenna group including the first antenna. The at least one communication processor can be configured such that it is determined, on the basis of a confirmation that a SAR accumulation value corresponding to the first antenna group satisfies a designated condition, that a third RF signal for non-cellular communication is provided to a third antenna included in a second antenna group differing from the first antenna group. The at least one communication processor can be configured to provide, to the at least one short-range communication module, a control signal that causes the third RF signal for the non-cellular communication to be provided to the third antenna. The short-range communication module can be configured to control, on the basis the reception of the control signal, that the third RF signal for the non-cellular communication is provided to the third antenna. Other embodiments are possible.

### CROSS-REFERENCE TO RELATED APPLICATIONS

This application is a continuation application of International Application No. PCT/KR2024/005230, filed on Apr. 18, 2024, in the Korean Intellectual Property Receiving Office, and claiming priority to Korean Patent Application No. 10-2023-0052792 filed Apr. 21, 2023 and Korean Patent Application No. 10-2023-0067574 filed May 25, 2023, the disclosures of which are all hereby incorporated by reference herein in their entireties.

### TECHNICAL FIELD

Certain example embodiments may relate to an electronic device changing a transmission antenna and/or a method for operating the same.

### BACKGROUND

A user equipment (UE) may transmit electromagnetic waves to transmit/receive data to/from a base station. Electromagnetic waves radiated from the UE may harm the human body, and various domestic or foreign organizations attempt to restrict the harmful electromagnetic waves. For example, the specific absorption rate (SAR) is a value indicating how much electromagnetic radiation from a mobile communication terminal is absorbed by the human body. SAR uses the unit of KW/g (or mW/g), which may mean the amount of power (KW, W or mW) absorbed per Ig of the human body. As the issue of harmfulness of electromagnetic waves attracts attention, SAR limit standards for mobile communication terminals have been established.

The UE may back off the transmission power, the maximum transmission power level (MTPL), e.g., if the SAR expected by the transmission power is expected to exceed a threshold. For example, upon identifying that a specific event (e.g., a grip, hot-spot, or proximity) occurs, the UE may transmit an RF signal in the backoff power corresponding to the event or transmit an RF signal in the transmission power set based on the maximum transmission power level.

Further, there is also used technology of backing off the transmission power (or maximum transmission power level) based on the total SAR value accumulated for a predetermined time (or the average of the SARs generated for a predetermined time). The SAR that instantaneously affects the human body and/or the SAR that affects the human body on average should also be considered. Therefore, the transmission power (or maximum transmission power level) when the total SAR value accumulated (or the average of the SARs generated for a predetermined time) meets a designated condition may be backed off.

The UE may support Bluetooth-based communication and/or Wi-Fi (e.g., IEEE 802.11 series, etc.) as well as cellular data communication. A user equipment may simultaneously transmit at least a plurality of signals among an uplink signal for cellular data communication, an uplink signal for Bluetooth communication, and an uplink signal for Wi-Fi communication. Alternatively, the user equipment may transmit a plurality of signals among an uplink signal for cellular data communication, an uplink signal for Bluetooth communication, and an uplink signal for Wi-Fi communication within a time table for considering an average SAR. In the above cases, the sum of the SARs generated by the plurality of uplink signals should satisfy SAR regulations. Accordingly, a backoff operation for at least one communication may be required to be performed.

### SUMMARY

According to an example embodiment, an electronic device may include at least one communication processor comprising processing circuitry, and at least one short-range communication module comprising communication circuitry. The at least one communication processor may be configured to control a first RF signal for cellular communication to be provided to a first antenna. The at least one short-range communication module may be configured to control a second RF signal for non-cellular communication to be provided to a second antenna included in a first antenna group including the first antenna. The at least one communication processor may be configured to determine that a third RF signal for non-cellular communication is provided to a third antenna included in a second antenna group different from the first antenna group, based on identifying that a SAR cumulative value corresponding to the first antenna group satisfies a designated condition. The at least one communication processor may be configured to provide the at least one short-range communication module with a control signal causing the third RF signal for the non-cellular communication to be provided to the third antenna. The short-range communication module may be configured to control the third RF signal for the non-cellular communication to be provided to the third antenna, based on receiving the control signal.

A method for operating the electronic device according to an example embodiment may include controlling, by at least one communication processor of the electronic device, a first RF signal for cellular communication to be provided to a first antenna. The method for operating the electronic device may include controlling, by at least one short-range communication module, a second RF signal for non-cellular communication to be provided to a second antenna included in a first antenna group including the first antenna. The method for operating the electronic device may include determining, by the at least one communication processor, that a third RF signal for non-cellular communication is to be provided to a third antenna included in a second antenna group different from the first antenna group, based on identifying that a SAR cumulative value corresponding to the first antenna group satisfies a designated condition. The method for operating the electronic device may include providing, by the at least one communication processor, the at least one short-range communication module with a control signal causing the third RF signal for the non-cellular communication to be provided to the third antenna. The method for operating the electronic device may include controlling, by the short-range communication module, the third RF signal for the non-cellular communication to be provided to the third antenna, based on receiving the control signal.

According to an embodiment, in a storage medium storing computer-readable instructions, the instructions may, when executed by at least one processor of the electronic device, cause the electronic device to identify, for a first antenna group of the electronic device, a first SAR cumulative value based on cellular communication and a second SAR cumulative value based on non-cellular communication. The instructions may, when executed by at least one processor of the electronic device, the electronic device to identify that the first SAR cumulative value and the second SAR cumulative value satisfy a designated condition. The instructions may, when executed by at least one processor of the electronic device, may cause the electronic device to allocate either the cellular communication or the non-cellular communication to a second antenna group, based on satisfaction of the designated condition.

According to an example embodiment, an electronic device may include at least one communication processor and at least one short-range communication module. The at least one communication processor may be configured to control a first RF signal for cellular communication to be provided to a first antenna. The at least one communication processor may be configured to identify an activation event of non-cellular communication. The at least one communication processor may be configured to identify to use a second antenna included in a second antenna group different from a first antenna group including the first antenna, for the non-cellular communication, based on identifying the activation event. The at least one communication processor may be configured to provide the at least one short-range communication module with a control signal causing use of the second antenna. The at least one short-range communication module may be configured to control a second RF signal for the non-cellular communication to be provided to the second antenna included in the second antenna group, based on receiving the control signal.

According to an embodiment, a method for operating the electronic device may include controlling, by at least one communication processor, a first RF signal for cellular communication to be provided to a first antenna. The method for operating the electronic device may include identifying, by the at least one communication processor, an activation event of non-cellular communication. The method for operating the electronic device may include identifying, by the at least one communication processor, to use a second antenna included in a second antenna group different from a first antenna group including the first antenna, for the non-cellular communication, based on identifying the activation event. The method for operating the electronic device may include providing, by the at least one communication processor, the at least one short-range communication module with a control signal causing use of the second antenna. The method for operating the electronic device may include controlling, by at least one short-range communication module, a second RF signal for the non-cellular communication to be provided to the second antenna included in the second antenna group, based on receiving the control signal.

According to an example embodiment, in a storage medium storing computer-readable instructions, the instructions may, when executed individually and/or collectively by at least one processor of the electronic device, cause the electronic device to allocate cellular communication to a first antenna group of the electronic device. The instructions may, when executed individually and/or collectively by at least one processor of the electronic device, cause the electronic device to identify an activation event of non-cellular communication. The instructions may, when executed individually and/or collectively by at least one processor of the electronic device, cause the electronic device to allocate the non-cellular communication to a second antenna group different from the first antenna group, based on identifying the activation event.

### BRIEF DESCRIPTION OF DRAWINGS

FIG. 1 is a block diagram illustrating an electronic device in a network environment according to an example embodiment;

FIG. 2A is a block diagram illustrating an electronic device for supporting legacy network communication and 5G network communication according to an example embodiment;

FIG. 2B is a block diagram illustrating an electronic device for supporting legacy network communication and 5G network communication according to an example embodiment;

FIG. 3A is a flowchart illustrating a method of operating an electronic device according to an example embodiment;

FIG. 3B is a view illustrating transmission power and SAR over time according to an example embodiment;

FIGS. 4A, 4B, and 4C illustrate graphs of transmission power per time according to an example embodiment;

FIGS. 4D to 4E illustrate tables of transmission power per time according to an example embodiment;

FIG. 5A is a block diagram illustrating an example electronic device according to an example embodiment;

FIG. 5B is a view illustrating an example electronic device according to an example embodiment;

FIG. 5C is a view illustrating an example electronic device according to an example embodiment;

FIG. 6A is a flowchart illustrating an operation method of an electronic device according to an example embodiment;

FIG. 6B is a view illustrating transmission antenna change of an electronic device according to an example embodiment;

FIG. 6C is a flowchart illustrating an operation method of an electronic device according to an example embodiment;

FIG. 6D is a flowchart illustrating an operation method of an electronic device according to an example embodiment;

FIG. 6E is a flowchart illustrating an operation method of an electronic device according to an example embodiment;

FIG. 7 is a flowchart illustrating an operation method of an electronic device according to an example embodiment;

FIG. 8A is a view illustrating a maximum cellular transmission power value and a maximum Wi-Fi transmission power value for comparison with an example embodiment;

FIG. 8B is a view illustrating a maximum cellular transmission power value and a maximum Wi-Fi transmission power value according to an example embodiment;

FIG. 9A illustrates a flowchart for describing an operation method of an electronic device according to an example embodiment;

FIG. 9B is a view illustrating transmission antenna change of an electronic device according to an example embodiment;

FIG. 10 is a flowchart illustrating an operation method of an electronic device according to an example embodiment;

FIG. 11 is a view illustrating transmission antenna change of an electronic device according to an example embodiment;

FIG. 12A is a view illustrating reduction of a back-off period according to an example embodiment;

FIG. 12B is a view illustrating reduction of a back-off period according to an example embodiment;

FIG. 12C is a view illustrating reduction of a back-off period according to an example embodiment;

FIG. 12D is a view illustrating back-off prevention according to an example embodiment;

FIGS. 13A and 13B are views illustrating various transmission states according to example embodiments.

FIG. 14A is a flowchart illustrating an operation method of an electronic device according to an example embodiment;

FIG. 14B is a view illustrating transmission antenna change of an electronic device according to an example embodiment;

FIG. 15A is a flowchart illustrating an operation method of an electronic device according to an example embodiment; and

FIG. 15B is a view illustrating transmission antenna change of an electronic device according to an example embodiment.

### DETAILED DESCRIPTION

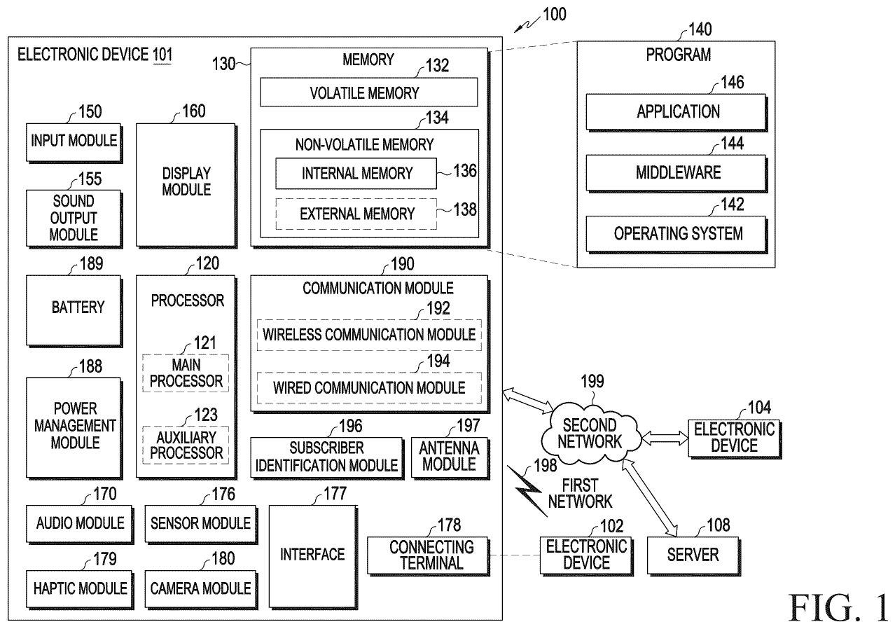

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the sub processor 123, the sub processor 123 may be configured to use lower power than the main processor 121 or to be specified for a designated function. The sub processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (QEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

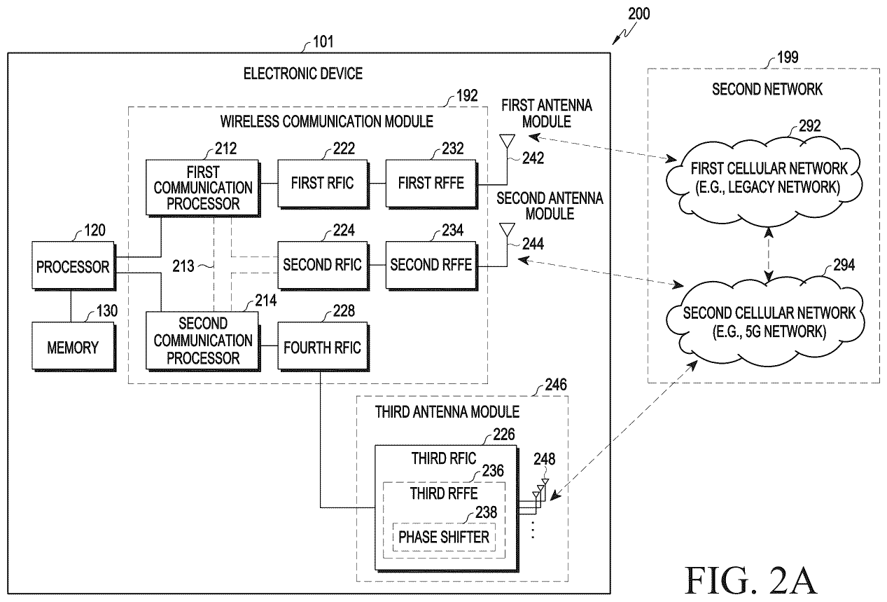

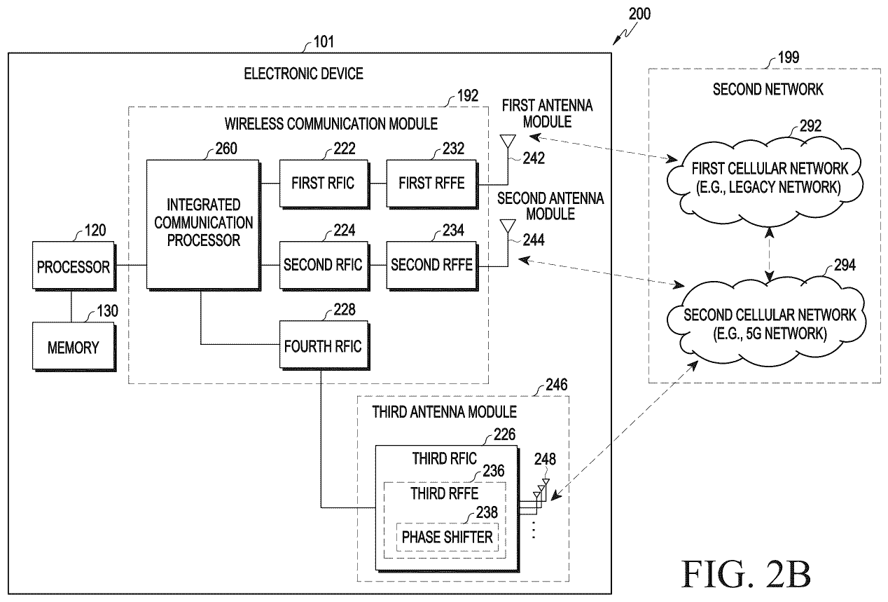

FIG. 2A is a block diagram 200 illustrating an electronic device 101 for supporting legacy network communication and 5G network communication according to an embodiment. Referring to FIG. 2A, the electronic device 101 may include a first communication processor 212 comprising processing circuitry, a second communication processor 214 comprising processing circuitry, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include a processor 120, comprising processing circuitry, and memory 130. The second network 199 may include a first cellular network 292 and a second cellular network 294. According to an embodiment, the electronic device 101 may further include at least one component among the components of FIG. 1, and the second network 199 may further include at least one other network. According to an embodiment, the first communication processor 212 comprising circuitry, the second communication processor 214 comprising circuitry, the first RFIC 222, the second RFIC 224, the fourth RFIC 228, the first RFFE 232, and the second RFFE 234 may form at least part of the wireless communication module 192. According to another embodiment, the fourth RFIC 228 may be omitted or be included as part of the third RFIC 226.

The first communication processor 212 may establish a communication channel of a band that is to be used for wireless communication with the first cellular network 292 or may support legacy network communication via the established communication channel. According to an embodiment, the first cellular network may be a legacy network that includes second generation (2G), third generation (3G), fourth generation (4G), or long-term evolution (LTE) networks. The second communication processor 214 may establish a communication channel corresponding to a designated band (e.g., from about 6 GHz to about 60 GHz) among bands that are to be used for wireless communication with the second cellular network 294 or may support fifth generation (5G) network communication via the established communication channel. According to an embodiment, the second cellular network 294 may be a 5G network defined by the 3rd generation partnership project (3GPP). Additionally, according to an embodiment, the first communication processor 212 or the second communication processor 214 may establish a communication channel corresponding to another designated band (e.g., about 6 GHz or less) among the bands that are to be used for wireless communication with the second cellular network 294 or may support fifth generation (5G) network communication via the established communication channel.

The first communication processor 212 may perform data transmission/reception with the second communication processor 214. For example, data classified as transmitted via the second cellular network 294 may be changed to be transmitted via the first cellular network 292. In this case, the first communication processor 212 may receive transmission data from the second communication processor 214. For example, the first communication processor 212 may transmit/receive data to/from the second communication processor 214 via an inter-processor interface 213. The inter-processor interface 213 may be implemented as, e.g., universal asynchronous receiver/transmitter (UART) (e.g., high speed-UART (HS-UART)) or peripheral component interconnect bus express (PCIe) interface, but is not limited to a specific kind. The first communication processor 212 and the second communication processor 214 may exchange packet data information and control information using, e.g., a shared memory. The first communication processor 212 may transmit/receive various types of information, such as sensing information, information about output strength, and resource block (RB) allocation information, to/from the second communication processor 214.

According to implementation, the first communication processor 212 may not be directly connected with the second communication processor 214. In this case, the first communication processor 212 may transmit/receive data to/from the second communication processor 214 via a processor 120 (e.g., an application processor). For example, the first communication processor 212 and the second communication processor 214 may transmit/receive data to/from the processor 120 (e.g., an application processor) via an HS-UART interface or PCIe interface, but the kind of the interface is not limited thereto. The first communication processor 212 and the second communication processor 214 may exchange control information and packet data information with the processor 120 (e.g., an application processor) using a shared memory.

According to an embodiment, the first communication processor 212 and the second communication processor 214 may be implemented in a single chip or a single package. According to an embodiment, the first CP 212 or the second CP 214, along with the processor 120, an assistance processor 123, or communication module 190, may be formed in a single chip or single package. For example, as shown in FIG. 2B, an integrated communication processor 260 may support all of the functions for communication with the first cellular network 292 and the second cellular network 294. Of course, each chip comprises processing circuitry.

As described above, at least one of the processor 120, the first communication processor 212, the second communication processor 214, or the integrated communication processor 260 may be implemented as a single chip or a single package. In this case, the single chip or single package may include memory (or storage means) storing instructions that cause at least some of operations performed according to an embodiment and a processing circuit (or operation circuit, but the term is not limited) for executing instructions.

Upon transmission, the first RFIC 222 may convert a baseband signal generated by the first communication processor 212 into a radio frequency (RF) signal with a frequency ranging from about 700 MHz to about 3 GHz which is used by the first cellular network 292 (e.g., a legacy network). Upon receipt, the RF signal may be obtained from the first network 292 (e.g., a legacy network) through an antenna (e.g., the first antenna module 242) and be pre-processed via an RFFE (e.g., the first RFFE 232). The first RFIC 222 may convert the pre-processed RF signal into a baseband signal that may be processed by the first communication processor 212.

Upon transmission, the second RFIC 224 may convert the baseband signal generated by the first communication processor 212 or the second communication processor 214 into a Sub6-band (e.g., about 6 GHz or less) RF signal (hereinafter, “5G Sub6 RF signal”) that is used by the second cellular network 294 (e.g., a 5G network). Upon receipt, the 5G Sub6 RF signal may be obtained from the second cellular network 294 (e.g., a 5G network) through an antenna (e.g., the second antenna module 244) and be pre-processed via an RFFE (e.g., the second RFFE 234). The second RFIC 224 may convert the pre-processed 5G Sub6 RF signal into a baseband signal that may be processed by a corresponding processor of the first communication processor 212 and the second communication processor 214.

The third RFIC 226 may convert the baseband signal generated by the second CP 214 into a 5G Above6 band (e.g., from about 6 GHz to about 60 GHz) RF signal (hereinafter, “5G Above6 RF signal”) that is to be used by the second cellular network 294 (e.g., a 5G network). Upon receipt, the 5G Above6 RF signal may be obtained from the second cellular network 294 (e.g., a 5G network) through an antenna (e.g., the antenna 248) and be pre-processed via the third RFFE 236. The third RFIC 226 may convert the pre-processed 5G Above6 RF signal into a baseband signal that may be processed by the second communication processor 214. According to an embodiment, the third RFFE 236 may be formed as part of the third RFIC 226.

According to an embodiment, the electronic device 101 may include the fourth RFIC 228 separately from, or as at least part of, the third RFIC 226. In this case, the fourth RFIC 228 may convert the baseband signal generated by the second communication processor 214 into an intermediate frequency band (e.g., from about 9 GHz to about 11 GHz) RF signal (hereinafter, “IF signal”) and transfer the IF signal to the third RFIC 226. The third RFIC 226 may convert the IF signal into a 5G Above6 RF signal. Upon receipt, the 5G Above6 RF signal may be received from the second cellular network 294 (e.g., a 5G network) through an antenna (e.g., the antenna 248) and be converted into an IF signal by the third RFIC 226. The fourth RFIC 228 may convert the IF signal into a baseband signal that may be processed by the second communication processor 214.

According to an embodiment, the first RFIC 222 and the second RFIC 224 may be implemented as at least part of a single chip or single package. According to an embodiment, when the first RFIC 222 and the second RFIC 224 in FIG. 2A or 2B are implemented as a single chip or a single package, they may be implemented as an integrated RFIC. In this case, the integrated RFIC is connected to the first RFFE 232 and the second RFFE 234 to convert a baseband signal into a signal of a band supported by the first RFFE 232 and/or the second RFFE 234, and may transmit the converted signal to one of the first RFFE 232 and the second RFFE 234. According to an embodiment, the first RFFE 232 and the second RFFE 234 may be implemented as at least part of a single chip or single package. According to an embodiment, at least one of the first antenna module 242 or the second antenna module 244 may be omitted or be combined with another antenna module to process multi-band RF signals.

According to an embodiment, the third RFIC 226 and the antenna 248 may be disposed on the same substrate to form the third antenna module 246. For example, the wireless communication module 192 or the processor 120 may be disposed on a first substrate (e.g., a main printed circuit board (PCB)). In this case, the third RFIC 226 and the antenna 248, respectively, may be disposed on one area (e.g., the bottom) and another (e.g., the top) of a second substrate (e.g., a sub PCB) which is provided separately from the first substrate, forming the third antenna module 246. Placing the third RFIC 226 and the antenna 248 on the same substrate may shorten the length of the transmission line therebetween. This may reduce a loss (e.g., attenuation) of high-frequency band (e.g., from about 6 GHz to about 60 GHz) signal used for 5G network communication due to the transmission line. Thus, the electronic device 101 may enhance the communication quality with the second network 294 (e.g., a 5G network).

According to an embodiment, the antenna 248 may be formed as an antenna array which includes a plurality of antenna elements available for beamforming. In this case, the third RFIC 226 may include a plurality of phase shifters 238 corresponding to the plurality of antenna elements, as part of the third RFFE 236. Upon transmission, the plurality of phase shifters 238 may change the phase of the 5G Above6 RF signal which is to be transmitted to the outside (e.g., a 5G network base station) of the electronic device 101 via their respective corresponding antenna elements. Upon receipt, the plurality of phase shifters 238 may change the phase of the 5G Above6 RF signal received from the outside to the same or substantially the same phase via their respective corresponding antenna elements. This enables transmission or reception via beamforming between the electronic device 101 and the outside.

The second cellular network 294 (e.g., a 5G network) may be operated independently (e.g., as standalone (SA)) from, or in connection (e.g., as non-standalone (NSA)) with the first cellular network 292 (e.g., a legacy network). For example, the 5G network may have the access network (e.g., 5G radio access network (RAN) or next generation RAN (NG RAN)) but may not have the core network (e.g., next generation core (NGC)). In this case, the electronic device 101, after accessing a 5G network access network, may access an external network (e.g., the Internet) under the control of the core network (e.g., the evolved packet core (EPC)) of the legacy network. Protocol information (e.g., LTE protocol information) for communication with the legacy network or protocol information (e.g., New Radio (NR) protocol information) for communication with the 5G network may be stored in the memory 230 and be accessed by other components (e.g., the processor 120, the first communication processor 212, or the second communication processor 214).

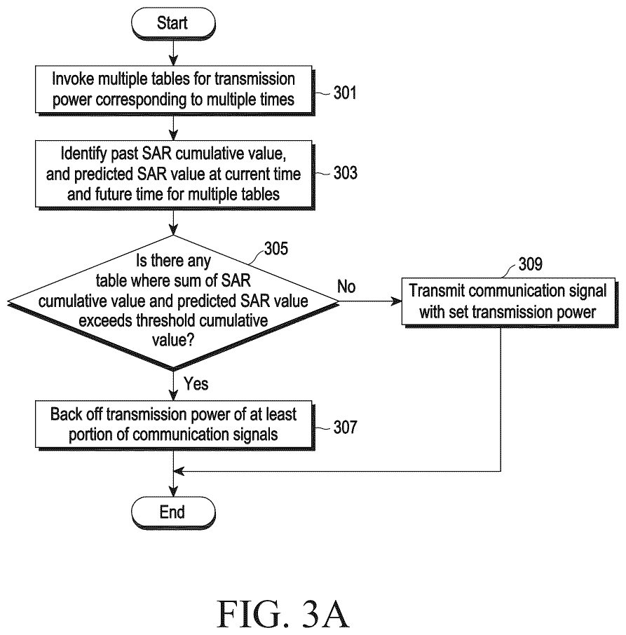

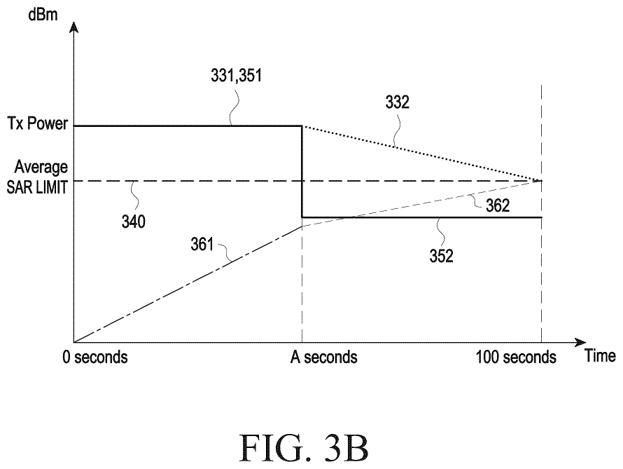

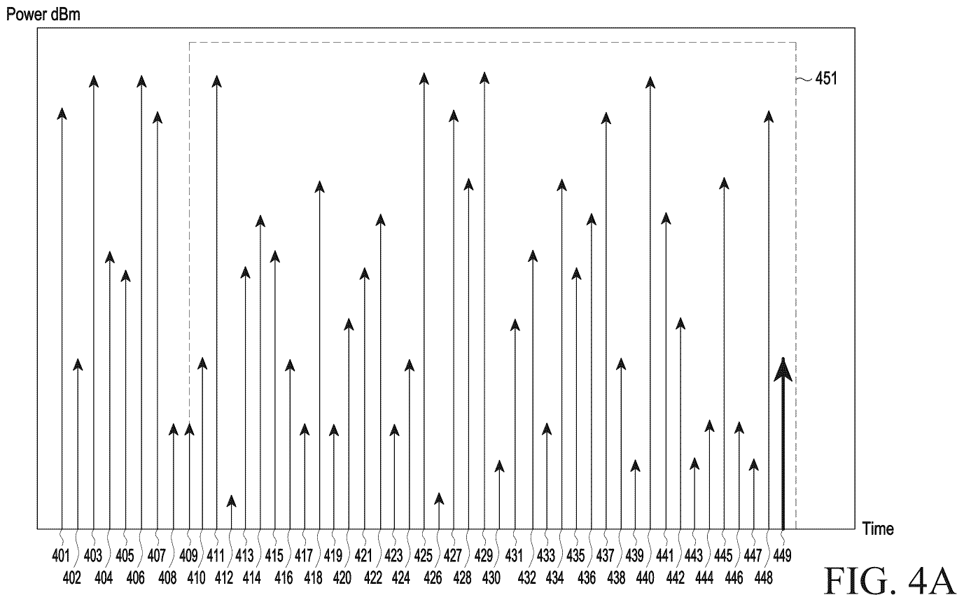

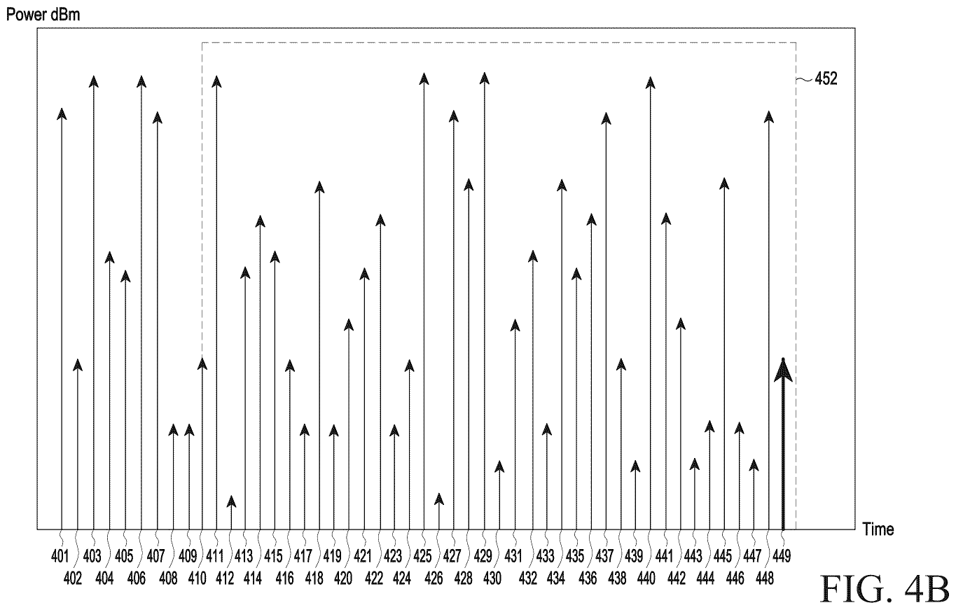

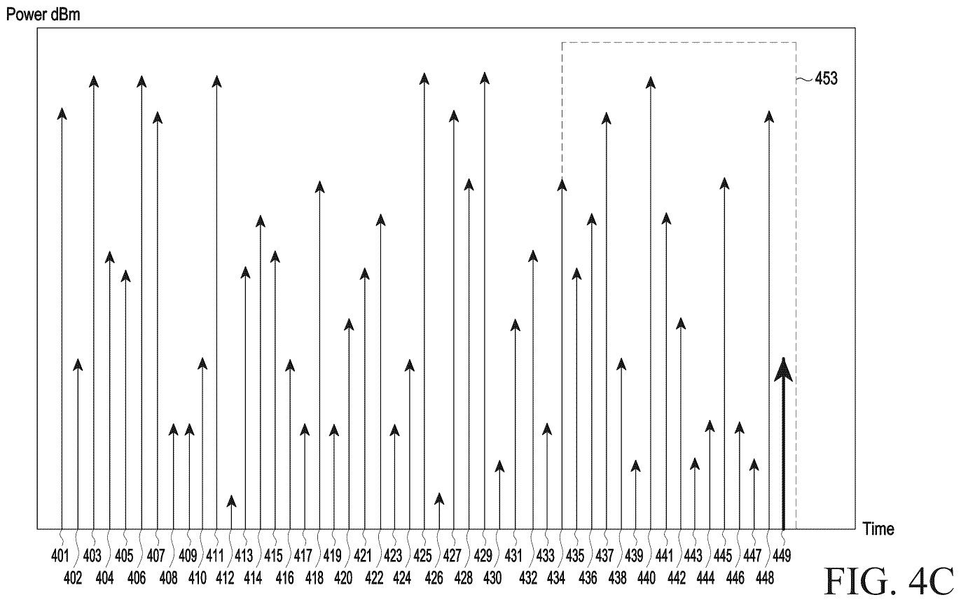

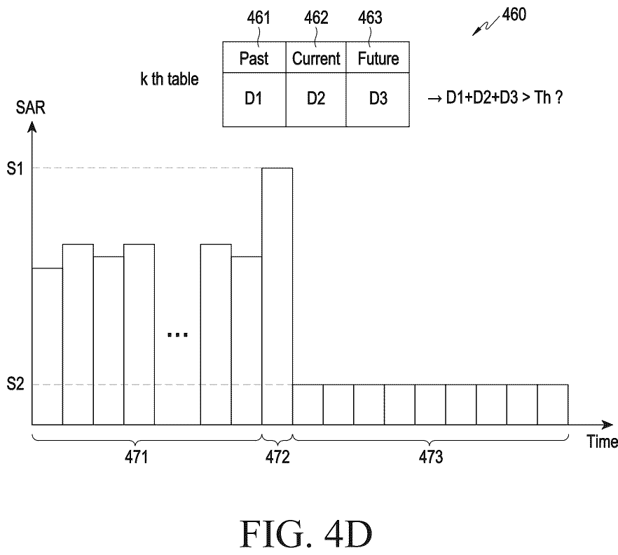

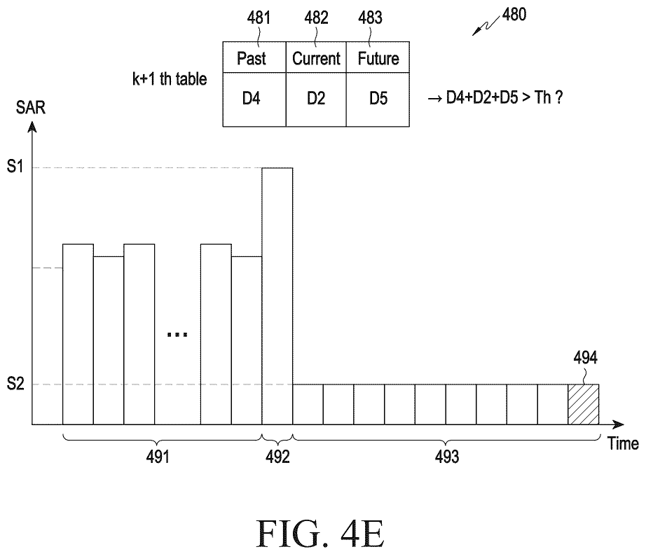

FIG. 3A is a flowchart illustrating a method of operating an electronic device according to an embodiment. The embodiment of FIG. 3A is described with reference to FIGS. 3B and 4A to 4E. FIG. 3B is a view illustrating transmission power and SAR over time according to an embodiment. FIGS. 4A to 4C illustrate graphs of transmission power per time according to an embodiment. FIGS. 4D to 4E illustrate tables of transmission power per time according to an embodiment.

According to an embodiment, an electronic device 101 (e.g., at least one of the processor 120, the first communication processor 212, the second communication processor 214, or the integrated communication processor 260) may invoke (or read) a plurality of tables for the transmission power corresponding to a plurality of times in operation 301. Before describing the embodiment associated with FIG. 3A, terms as shown in Table 1 are defined.

TABLE 1
a. Normal MAX Power: the maximum transmission power when SAR margin remains
b. Normal Max SAR: the value of SAR generated in normal MAX power
c. Backoff MAX Power: the maximum transmission power when back-off is performed due to
shortage of SAR margin
d. Backoff Max SAR: the value of SAR generated when operating in backoff max power
e. Measurement Time(T): period for calculating the accumulated SAR or SAR average
f. Measurement Period(P): period (or time interval) for calculating SAR
g. Number of tables for calculating SAR: T/P − 1
h. Average SAR LIMIT: the maximum value of the average SAR that should not be exceeded
during T
i. Average Time(A_Time): the time measured with SARs accumulated
j. Accumulated SAR : the sum of SARs accumulated for average time.
k. Max accumulated SAR : Average SAR LIMIT X measurement Time
l. Average SAR : the value of average SAR used for average Time
m. Tx Room : Max accumulated SAR − accumulated SAR, SAR remaining after use
n. Remain Time(R_Time) : total measurement time − time (A_Time) during which SAR is
measured up to now

First, the table is described with reference to FIGS. 4A to 4C. Referring to FIG. 4A, a graph including transmission power for a plurality of times 401 to 449 is illustrated. The accumulated SAR (the accumulated SAR of Table 1) for a measurement time (the measurement time of Table 1), e.g., an measurement time including 50 time points, may be required to maintain a value below the maximum accumulated SAR (the max accumulated SAR of Table 1). The electronic device 101 may determine the transmission power of an RF signal to be transmitted at the current time point 449 to allow the accumulated SAR of nine future time points (e.g., the remain time of Table 1) in addition to the accumulated SAR at the current time point 449 and any past time points 409 to 448 (e.g., the average time of Table 1) to maintain below the maximum accumulated SAR. Further, as shown in FIG. 4B, the electronic device 101 may identify the transmission powers 452 which are one time point shifted from the transmission powers 451 at the current time point 449 and any past time points 409 to 448. Shifting by one time point may mean not reflecting data at the oldest time point (e.g., time point 409 in FIG. 4A). The number of transmission powers 452 at the current time point 449 and any past time points 410 to 448 is 40 and may be one smaller than the number, 41, of the transmission powers 451 of FIG. 4A. The electronic device 101 may determine the transmission power at the current time point 449 to allow the sum of the SAR by the transmission powers 452 and the SAR predicted at additional future 10 time points to maintain the maximum accumulated SAR or less. As shown in FIG. 4C, the electronic device 101 may identify the transmission powers 453 at the current time point 449 and any past time points 434 to 448 which are 25 time point shifted from the transmission powers 451. The number of transmission powers 453 is 16 and may be 25 smaller than the number, 41, of the transmission powers 451 of FIG. 4A. The electronic device 101 may determine the transmission power at the current time point 449 to allow the sum of the SAR by the transmission powers 453 and the SAR predicted at additional future 34 time points to maintain the maximum accumulated SAR or less. Although not shown, the electronic device 101 may manage a plurality of graphs each of which is one time point shifted. The period of calculating the SAR is the measurement period P of Table 1 and may be, e.g., the interval between the transmission powers in FIGS. 4A to 4C. The electronic device 101 may calculate and/or manage T/P-1 tables for a specific time point.

Hereinafter, a configuration of identifying an expected SAR value is described with reference to FIGS. 4D and 4E.

Referring to FIG. 4D, the electronic device 101 may identify the kth SAR table 460. The kth SAR table 460 may include D1, which is the accumulated SAR value 461 at at least one past time point, the maximum SAR value (D2) 462 at the current time, and the expected SAR value (D3) 463 at at least one future time point. Referring to the graph, the accumulated SAR value corresponding to at least one past time point 461 may be D1. D1, which is the accumulated SAR value 461 at at least one past time point may be identified based on the antenna configuration. The number of at least one past time point may be a number that is one smaller than the total number (e.g., 100) of time points corresponding to the measurement time (e.g., 50 seconds) in the first table. N, which is the total number (e.g., 100) of time points may be a result of dividing the measurement time by the sampling period (or shift period). Accordingly, in the kth table, the number of at least one past time point may be k smaller than the total number of time points. The electronic device 101 may identify D1 which is the accumulated SAR value of the N−k past time points 471. The electronic device 101 may use the maximum SAR value S1 for the current time point 472. The maximum SAR value S1 (e.g., the normal max SAR in Table 1) may be the SAR value corresponding to a designated maximum transmission power (e.g., the normal max power of Table 1) in the electronic device 101. In an embodiment, for the current time point 472, the SAR value immediately before the current time point 472 may be used. In an embodiment, for the current time point 472, the average SAR value for the past time points 471 of the current time point 472 may be used. The electronic device 101 may calculate the sum of SAR values S2 (e.g., the backoff max SAR of Table 1) for the transmission power (e.g., the backoff max power of Table 1) backed off, for at least one future time point 473. The electronic device 101 may identify D3 as the accumulated SAR for at least one future time point 473. In the kth table, the number of at least one future time point may be k−1. Accordingly, the electronic device 101 may identify whether the total SAR sum D1+D2+D3 for N time points including N−k past time points, one current time point, and k−1 future time points exceeds the maximum accumulated SAR, for the kth table. Upon identifying the excess, the electronic device 101 may back off the transmission power of the current time point. Referring to FIG. 4E, the electronic device 101 may identify the k+1th table 480 as shown in FIG. 4E. For the k+1th table 480, the electronic device 101 may identify D4, which is the accumulated SAR value 481 of at least one past time point, D2, which is the maximum SAR value 482 of the current time point, and D5, which is the expected SAR value 483 of at least one future time point. The electronic device 101 may identify whether the accumulated SAR value of D4+D2+D5 exceeds the maximum accumulated SAR. The number of at least one past time point 491 in the k+1th table may be one smaller than the number of at least one past time point 471 in the kth table. The number of at least one future time point 493 in the k+1th table may be one (494) larger than the number of at least one future time point 473 in the kth table.

According to an embodiment, in operation 303, the electronic device 101 may identify the past accumulated SAR value and the expected SAR value at the current time point and future time point for a plurality of tables corresponding to at least one future time point. The electronic device 101 may identify the accumulated SAR value for a first table and a total of N−1 tables, which are shifted by i time points (where i is 1 or more and less than N−2) from the first table. In operation 305, the electronic device 101 may identify whether there is a table in which the sum of the accumulated SAR value and the expected SAR value exceeds a threshold. If there is a table exceeding the threshold (yes in 305), the electronic device 101 may back off any one (or the maximum transmission power level (MTPL)) of at least some transmission powers of the RF signals in operation 307. It will be appreciated by one of ordinary skill in the art that the back-off of transmission power may be replaced with back-off of maximum transmission power level in the disclosure. If there is no table exceeding the threshold (no in 305), the electronic device 101 may transmit an RF signal in the set transmission power in operation 309. The back-off of the maximum transmission power value may mean back-off of the maximum transmission power value in an embodiment of the disclosure.

As described above, the electronic device 101 may determine the maximum transmission power value so that the average SAR value used during the measurement time does not exceed the average SAR limit. Or, the electronic device 101 may determine the maximum transmission power value so that the accumulated SAR during the measurement time does not exceed the max accumulated SAR. The electronic device 101 may determine the maximum value of the maximum power for the next time period every time P. For example, conditions for operating in normal max power during next time P may be as follows.

Tx Room>SAR generated when operating in normal max power during next P (normal max SAR of Table 1)+SAR (backoff max SAR of Table 1) generated when operating in backoff max power during (Remain Time−P)=P×normal max SAR+(Remain Time−P)×backoff max SAR Condition:

In the condition, Tx Room may be the max accumulated SAR minus the SAR accumulated up to now. In the condition, (Remain Time−P) may be T−average time−P, e.g., the future time point described in connection with FIG. FIGS. 4A to 4E. P may mean the current time point. Average time may mean the past time point. Meeting the condition may mean that although the electronic device 101 sets the maximum transmission power of the normal max power during time P, there is no table in which the accumulated SAR exceeds the max accumulated SAR. Not meeting the condition may mean that there is a chance of presence of a table in which the accumulated SAR exceeds the max accumulated SAR if the electronic device 101 sets the maximum transmission power of the normal max power during time P, in which case the electronic device 101 may set the backoff max power as the maximum transmission power during time P.

Table 2 shows examples of variables and conditions.

TABLE 2
[Example of variable settings]

i. Normal MAX Power : 23dBm

| | |
|---|---|
| ii. | Backoff MAX Power : 20dBm |
| iii. | Measurement Time(T) : 100 seconds |
| iv. | Measurement Period(P) : 0.5 seconds |
| v. | Number of SAR Calculator tables : 199 |
| vi. | Average SAR LIMIT : 1.5mW/g |
| vii. | Max accumulated SAR : 150mW/g |
| viii. | When Normal Max SAR => 23dBm, SAR : 2mW/g |
| ix. | When Backoff Max SAR => 20dBm, SAR : 1mW/g |

[time point when the maximum power switches from normal max power to backoff max
power]Average time X normal max power + (100 − average time) X backoff max power <= time
point when accumulated max SAR is met
= Average time X 2 mW/g + (100 − average time) X 1mW/g <= 150 mW/g
<=> Average time <= 0

In the example of Table 2, it is described that continuous use of the normal max power in the maximum transmission power for 50 seconds is possible and, after 50 seconds, back-off to the backoff max power is required. For example, it is hypothesized to transmit an RF signal in 23 dBm which is the normal max power, for 50 seconds, transmit an RF signal in 23 dBm which is the normal max power for the next P (0.5 seconds), and transmit an RF signal in 20 dBm which is the backoff max power for 49.5 seconds which is (remain time−P). In this case, Tx Room may be 150 mW/g−50×2 mW/g, i.e., 50 mW/g. The SAR generated for time P may be 2 mW/g×0.5 seconds, i.e., 1 mW/g. The SAR generated during (remain time−P) may be 49.5 seconds×1 mW/g, i.e., 49.5 mW/g. In this case, it may be identified that the accumulated SAR during P and (remain time−P) is 50.5 mW/g which exceeds the Tx room, and thus, it is required to back off the maximum value of the transmission power at time P. The above-described example is described with reference to FIG. 3B which describes the transmission power associated with one RAT. For example, referring to FIG. 3B, up to A seconds (e.g., 50 seconds), the maximum transmission power may be set to the normal max power 351 but, after A seconds, it may be identified to be backed off to the backoff max power 352. The slope of the second portion 362 of the accumulated SAR may be formed to be smaller than the slope of the first portion 361 of the accumulated SAR according to the backoff of the maximum value of the maximum transmission power. It may be identified that the average SAR 331 before A seconds exceeds the average SAR limit 340, but at the time when it is 100 seconds according to backoff, the average SAR 332 is identical to the value of the average SAR limit 340. In an embodiment, the electronic device 101 may transmit an RF signal for cellular data communication and an RF signal for Bluetooth communication, or may transmit an RF signal for cellular data communication and an RF signal for Wi-Fi communication. For example, the electronic device 101 may transmit a first RF signal for cellular data communication and a second RF signal for Bluetooth communication. In this case, the electronic device 101 may back off the maximum value of the transmission power of at least one RF signal so that the accumulated SAR of the sum of both the RF signals does not exceed the accumulated max SAR. For example, the electronic device 101 may perform backoff on the transmission power of the RF signal for Bluetooth communication. For example, the electronic device 101 may back off the maximum transmission power level of the RF signal for Bluetooth communication. For example, the electronic device 101 may reduce the average SAR limit allocated for Bluetooth communication in which case the normal max power for Wi-Fi communication and/or the backoff max power may be reduced. The “average SAR limit” may also be referred to as a “SAR margin”. According to an embodiment, the electronic device 101 may change a transmission antenna of non-cellular communication (e.g., Bluetooth communication and/or Wi-Fi communication) based on satisfaction of a condition associated with back-off due to SAR (e.g., a condition where a SAR cumulative value is equal to or greater than a threshold cumulative value, or a condition where back-off has been performed, but there is no limitation). According to the change of the transmission antenna, cellular communication and non-cellular communication may be allocated to different antenna groups, so that a back-off period due to SAR may be shortened, a maximum value of transmission power backed off due to SAR may be increased, and/or back-off due to SAR may not be performed.

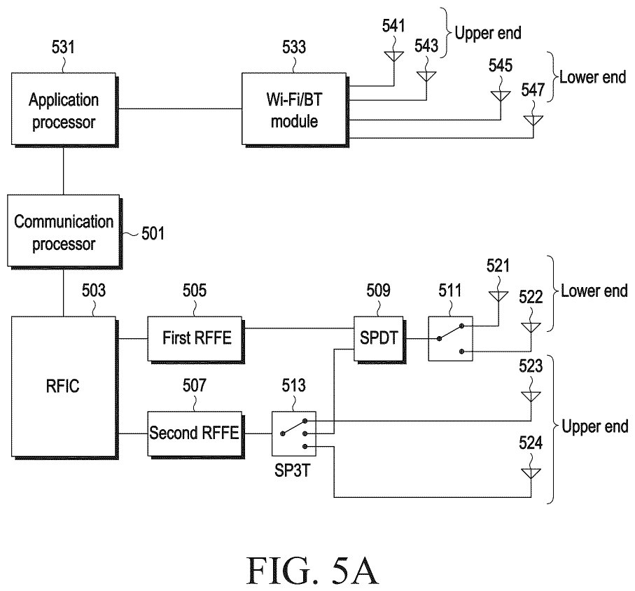

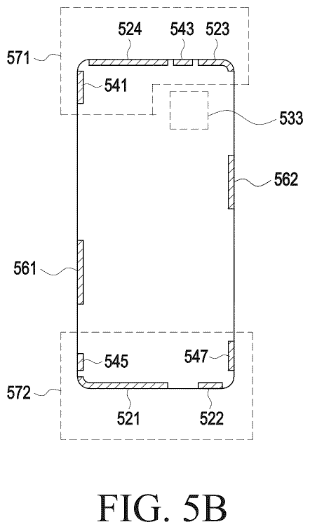

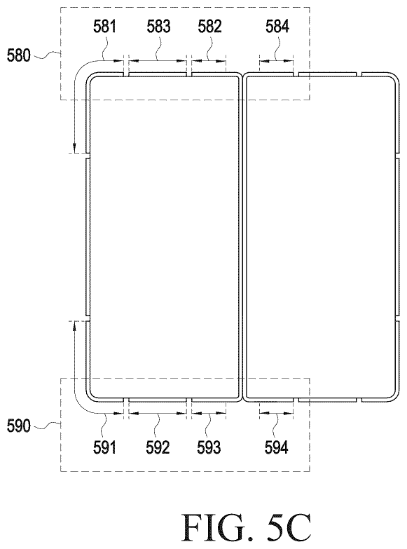

FIG. 5A is a block diagram illustrating an example electronic device according to an embodiment. The embodiment of FIG. 5A is described with reference to FIG. 5B. FIG. 5B is a view illustrating an example electronic device according to an embodiment.

According to an embodiment, the communication processor 501 (e.g., at least one of the first communication processor 212, the second communication processor 214, or the integrated communication processor 260) may transmit and/or receive a baseband signal to/from an RFIC 503 (e.g., at least one of the first RFIC 222, the second RFIC 224, the third RFIC 226, or the fourth RFIC 228). The RFIC 503 may process at least one RF signal associated with at least one RF path. Here, the RF path may include, e.g., at least one piece of hardware (e.g., at least one of an RFIC, RFFE, or antenna) for transmitting an RF signal. For example, the RFIC 503 may receive at least one baseband signal from the communication processor 501 and generate at least one or more RF signals. It will be appreciated by one of ordinary skill in the art that although the RFIC 503 is shown as one module in the example of FIG. 5A, this is an example, and the number of modules in which the RFIC 503 is implemented is not limited.

According to an embodiment, the RFIC 503 may provide at least one RF signal to the first RFFE 505 and/or the second RFFE 507. The first RFFE 505 and/or the second RFFE 507 may process (e.g., amplify) the received RF signal and provide the same. The communication processor 501 may determine the amplification degree of the RFFEs 505 and 507 based on the maximum transmission power level and/or transmission power determined as described above. Although not shown, the amplification degree of the RFFEs 505 and 507 may be controlled based on an average power tracking (APT) module and/or an envelope tracking (ET) module. According to an embodiment, one RFFE may process a plurality of RF signals.

According to an embodiment, the first RFFE 505 may be connected to a single pole double throw (SPDT) switch 509, and an output terminal of the SPDT switch 509 may be connected to the switch 511. The switch 511 may be configured to selectively connect the output terminal of the SPDT switch 509 to either the first antenna 521 or the second antenna 522. The second RFFE 507 may be connected to a single pole 3 throw (SP3T) switch 513. The SP4T switch 513 may be configured to selectively connect the output end of the second RFFE 507 to any one of the SPDT switch 509, the third antenna 523, or the fourth antenna 524. Meanwhile, each of the antennas 521, 522, 523, and 524 may be disposed inside the housing and/or may be disposed on a portion of the housing. For example, it may be disposed on the outer surface of the housing of the electronic device 101, but is not limited thereto. In one example, as shown in FIG. 5B, the antennas 521 and 522 may be disposed on one side (e.g., lower end) of the housing of the electronic device 101, and the antennas 523 and 524 may be disposed on the other side (e.g., upper end) of the housing of the electronic device 101, but this is exemplary. The antennas 545 and 547 for non-cellular communication may be disposed on one side (e.g., lower end) of the housing of the electronic device 101, and the antennas 541 and 543 may be disposed on the other side (e.g., upper end) of the housing of the electronic device 101, but this is exemplary.

Referring back to FIG. 5A, according to an embodiment, an application processor 531 (e.g., the processor 120) may be coupled to the communication processor 501. The application processor 531 may be connected to the Wi-Fi/BT module 533. In the example of FIG. 5A, although it is described as if the Wi-Fi/BT module 533 is implemented as one entity, this is exemplary, and those skilled in the art will understand that the electronic device 101 may be implemented to separately include a Wi-Fi module and a BT module. Accordingly, the Wi-Fi/BT module 533 may be referred to as at least one short-range communication module.

In the example of FIG. 5A, antennas 541, 543, 545, 547 may be connected to (or included in) the Wi-Fi/BT module 533. Some of the antennas 541, 543, 545, 547 may be antennas corresponding to a first frequency (which may be, e.g., 2.4 GHz, but there is no limitation), and some of the antennas 541, 543, 545, 547 may be antennas corresponding to a second frequency (which may be, e.g., 5 GHz, but there is no limitation), but there is no limitation, and all may be implemented as antennas corresponding to the same frequency. An antenna corresponding to the second frequency (which may be, e.g., 5 GHz, but there is no limitation) may not be used for Bluetooth communication, e.g., but there is no limitation. For example, the Wi-Fi/BT module 533 may include elements for RF signal processing, and in this case, the antennas 541, 543, 545, 547 may be connected to the elements for RF signal processing. Alternatively, the Wi-Fi/BT module 533 may be connected to the antennas 541, 543, 545, 547 through at least a portion of RF circuits (e.g., the RFIC 503, the RFFE 505, and/or the second RFFE 507). In this case, at least a portion of the RF circuits (e.g., the RFIC 503, the first RFFE 505, and/or the second RFFE 507) may be used for short-range communication (e.g., Wi-Fi communication and/or Bluetooth communication), and there is no limitation in the implementation. Accordingly, the Wi-Fi/BT module 533 providing an RF signal for Wi-Fi communication to at least a portion of the at least one antenna 541, 543, 545, 547 may mean that the Wi-Fi/BT module 533 directly applies the RF signal to at least a portion of the at least one antenna 541, 543, 545, 547, or controls at least a portion of the RF circuits so that the RF signal is provided to at least a portion of the at least one antenna 541, 543, 545, 547, and there is no limitation.

As described above, the Wi-Fi/BT module 533 may provide an RF signal for Wi-Fi communication to at least some of the at least one antenna 541, 543, 545, and 547 for Wi-Fi communication. Meanwhile, although FIG. 5B illustrates as if the electronic device 101 further includes antenna arrays 561 and 562 for mmWave, this is exemplary. In some cases, an RF signal for cellular data communication may be provided to at least some of the antennas 521, 522, 523, and 524, and an RF signal for Wi-Fi communication and/or Bluetooth communication may be provided to at least some of the antennas 541, 543, 545, and 547. For example, whether it is determined whether the SAR restrictions are violated based on the sum of exposures (e.g., SARs and/or PDs) generated by the plurality of antennas or it is determined whether the SAR restrictions are violated independently from the exposures generated by the plurality of antennas may be determined by Equation 1 below.

$${( {SAR}_{1} + {SAR}_{2} )}^{1.5} / R \leq 0.04 \qquad [ Equation 1 ]$$

In Equation 1, SAR₁ may be the SAR generated by one antenna, and SAR₂ may be the SAR generated by another antenna, and their unit may be, e.g., W/kg. R for the sum of various SARs may be shown in Table 3, for example. Meanwhile, the values, 1.5 and 0.04, in Equation 1 are merely exemplary and are not limited thereto.

TABLE 3

| Sum of SARs (SAR₁ + SAR₂) | Minimum separation distance |
|---|---|
| (W/Kg) | (minimum value of R) (mm) |
| 3.2 | 143 |
| 2.8 | 117 |
| 2.4 | 93 |
| 2 | 71 |
| 1.6 | 51 |
| 1.4 | 41 |
| 1.2 | 33 |
| 1.0 | 25 |
| 0.8 | 18 |

For example, it is hypothesized that the sum of SARs generated from the third antenna 523 and the antenna 541 is 3.2 W/Kg. For example, up to 1.6 W/Kg of SAR may be allocated to the third antenna 523 (e.g., cellular data), and up to 1.6 W/Kg of SAR may be allocated to the antenna 541 (e.g., Wi-Fi communication and/or Bluetooth communication), but the above values are exemplary. Meanwhile, as the third antenna 523 and the antenna 541 both are disposed at an upper end of the electronic device 101, the spacing may be less than 143 mm. In this case, to determine whether the SAR rule is instantaneously violated or the accumulated SAR rule is violated by the electronic device 101, it may be required to determine whether the sum of SARs generated from the third antenna 523 and the antenna 541 violates the SAR rule. To observe the SAR rule, the electronic device 101 may perform backoff associated with the transmission power of the RF signal for Wi-Fi communication and/or Bluetooth communication, for example. Meanwhile, when an RF signal in FR2 is transmitted, power density (PD) may replace SAR. For example, it will be appreciated by one of ordinary skill in the art that when SAR and PD both are considered, the sum of RF exposures may be identified as the sum of the value obtained by dividing the SAR by the maximum SAR and the value obtained by dividing the PD by the maximum PD, and the minimum spacing corresponding to the sum of RF exposures may be determined. Meanwhile, it is hypothesized that the sum of SARs generated from the first antenna 521 and the antenna 541 is 3.2 W/Kg. As the first antenna 521 and the antenna 541 are disposed at a lower end and an upper end, respectively, of the electronic device 101, the spacing may be 143 mm or more. In this case, to determine whether the accumulated SAR rule is violated by the electronic device 101, it may be required to determine whether the sum of SARs generated from the antenna 541 violates the SAR rule and/or whether the sum of SARs generated from the first antenna 521 violates the SAR rule. In this case, the electronic device 101 may refrain from performing back-off associated with the transmission power of the RF signal for Wi-Fi communication and/or Bluetooth communication, or may restore the maximum transmission power level that was back-off.

As described above, the antennas for which the sum of SARs is considered to determine whether the SAR rule is violated as Equation 1 is met may be represented as included in the same antenna group. When the distance between antennas is relatively small (e.g., smaller than the distance related to Equation 1), they may be included in the same antenna group. Further, the antennas for which SARs are considered independently, rather than the sum of SARs, to determine whether the SAR rule is violated as Equation 1 is not met may be represented as included in different antenna groups. When the distance between antennas is relatively large (e.g., larger than the distance related to Equation 1), they may be included in different antenna groups. For example, as illustrated in FIG. 5B, the antennas 523, 524, 541, 543 disposed on an upper side of the electronic device 101 may be included in a first antenna group 571, and the antennas 521, 522, 545, 547 disposed on a lower side of the electronic device 101 may be included in a second antenna group 572. A SAR margin may be allocated to each of the antenna groups 571, 572, and a SAR value of one antenna group may not be able to influence a SAR cumulative value and/or determination of back-off of another antenna group.

In the case where it is determined whether the maximum transmission power level is back-off based on the accumulated SAR (or average SAR), if the antenna for cellular data communication and the antenna for Wi-Fi communication and/or Bluetooth communication are included in different antenna groups, an average SAR limit may be allocated to cellular data communication, and another average SAR limit may be allocated to Wi-Fi communication and/or Bluetooth communication. For example, if the value average SAR limit is A, the average SAR limit of “A” may be allocated to cellular data communication, and the average SAR limit of “A” may be allocated to Wi-Fi communication and/or Bluetooth communication. Meanwhile, when the antenna for cellular data communication and antenna for Wi-Fi communication and/or Bluetooth communication are included in the same antenna group, the average SAR limits may need to be separately allocated to cellular data communication and Wi-Fi communication, respectively. For example, an Average SAR LIMIT of A1 may be allocated to cellular data communication, an Average SAR LIMIT of A2 may be allocated to Wi-Fi communication, and an Average SAR LIMIT of A3 may be allocated to Bluetooth communication, and the sum of A1, A2, and A3 may be A.

For example, Table 4 may be a distribution policy of values of the Average SAR LIMIT (or SAR margin).

TABLE 4

| | ratio of SAR margin allocated to |
|---|---|
| activated communication | Bluetooth communication |
| Bluetooth communication | 0.9 |
| Bluetooth communication and another | 0.3 |
| communication | |
| Bluetooth communication and two other | 0.2 |
| communications | |

The first row in Table 4 is for a case where only Bluetooth communication is activated within one antenna group, and 0.9 times the SAR margin allocated to the corresponding antenna group may be allocated to Bluetooth communication. When Bluetooth communication and one other communication are activated, 0.3 times the SAR margin allocated to the corresponding antenna group may be allocated to Bluetooth communication. When Bluetooth communication and two other communications (e.g., one cellular data communication and Wi-Fi communication, or two cellular communications (which may be, e.g., carrier aggregation (CA), dual connectivity (DC), and/or 2TX, but there is no limitation)) are activated, 0.2 times the SAR margin allocated to the corresponding antenna group may be allocated to Bluetooth communication. As described above, the electronic device 101 may determine whether to back off at least some of the communications using the first antenna group 571 based on a SAR cumulative value previously generated corresponding to at least some of the antennas 523, 524, 541, 543 included in the first antenna group 571. Further, the electronic device 101 may determine whether to back off at least some of the communications using the second antenna group 572 based on a SAR cumulative value previously generated corresponding to at least some of the antennas 521, 522, 545, 547 included in the second antenna group 572. Since whether to back off both antenna groups 571, 572 is determined independently of each other, the electronic device 101 may reduce a back-off period in one antenna group, increase a maximum value of transmission power backed off, and/or prevent back-off by performing transmission antenna change. For example, it is assumed that the electronic device 101 performs cellular communication using a first antenna 521 included in the second antenna group 572 and performs Wi-Fi communication using the antenna 547. Accordingly, the SAR cumulative value in the second antenna group 572 may be the sum of the SAR cumulative value based on cellular communication and the SAR cumulative value based on Wi-Fi communication. As the SAR cumulative value in the second antenna group 572 increases, back-off in the second antenna group 572 may be required and/or back-off may be performed. However, if the electronic device 101 changes the transmission antenna of Wi-Fi communication from the antenna 547 to the antenna 542 of the first antenna group 571, after the change, only the SAR value based on cellular communication will be accumulated in the second antenna group 572, so the back-off period in the second antenna group 572 may be decreased, the maximum value of transmission power backed off may be increased, and/or back-off may be prevented.

FIG. 5C is a view illustrating an example electronic device according to an embodiment.

According to an embodiment, the electronic device 101 may include antennas 581, 582, 583, 591, 592, 593 for cellular communication and antennas 584, 594 for non-cellular communication (e.g., Wi-Fi communication and/or Bluetooth communication). The electronic device 101 in the embodiment of FIG. 5C may be a foldable device, and although it is illustrated that the antennas 581, 582, 583, 591, 592, 593 for cellular communication are disposed in one housing and the antennas 584, 594 for non-cellular communication are disposed in another housing, this is exemplary and there is no limitation on the arrangement position and/or shape of the antennas. For example, an antenna for cellular communication and an antenna for non-cellular communication may be disposed together in one housing. The antennas 581, 582, 583 for cellular communication and the antenna 584 for non-cellular communication may be disposed on one side of the electronic device 101 and may be included in a first antenna group 580. The antennas 591, 592, 593 for cellular communication and the antenna 594 for non-cellular communication may be disposed on another side of the electronic device 101 and may be included in a second antenna group 590. The electronic device 101 may independently perform determination of whether to back off in the first antenna group 580 based on a SAR cumulative value for the first antenna group 580 and determination of whether to back off in the second antenna group 590 based on a SAR cumulative value for the second antenna group 590. As described above, according to the change of the transmission antenna, a back-off period in one antenna group may be decreased, a maximum value of transmission power backed off may be increased, and/or back-off may be prevented. For example, the electronic device 101 may perform cellular communication using the antenna 592 and perform Wi-Fi communication using the antenna 594. Accordingly, the SAR cumulative value in the second antenna group 590 may increase relatively rapidly, and back-off may be required and/or back-off may be performed. The electronic device 101 may change the transmission antenna for Wi-Fi communication to the antenna 584 included in the first antenna group 580. Accordingly, as only the SAR value due to cellular communication is accumulated in the first antenna group 580, the degree of increase may be decreased compared to before the change. Accordingly, the back-off period in the second antenna group 590 may be decreased, the maximum value of transmission power backed off may be increased, and/or back-off may be prevented.

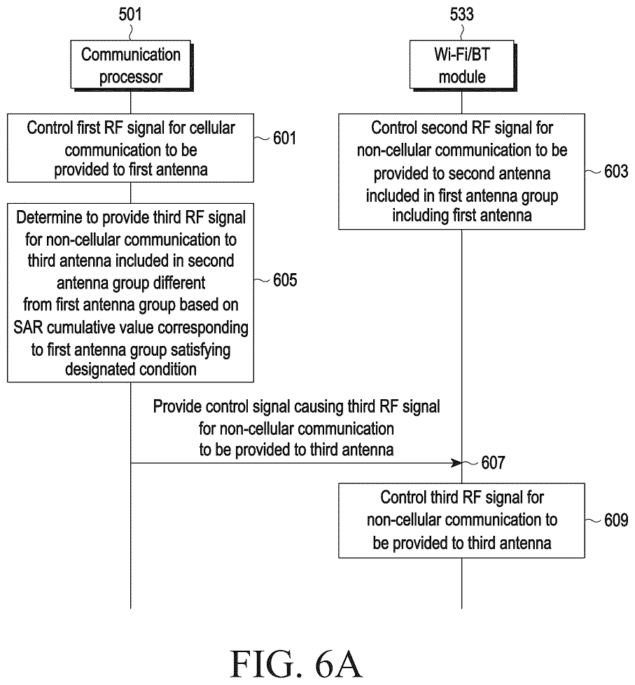

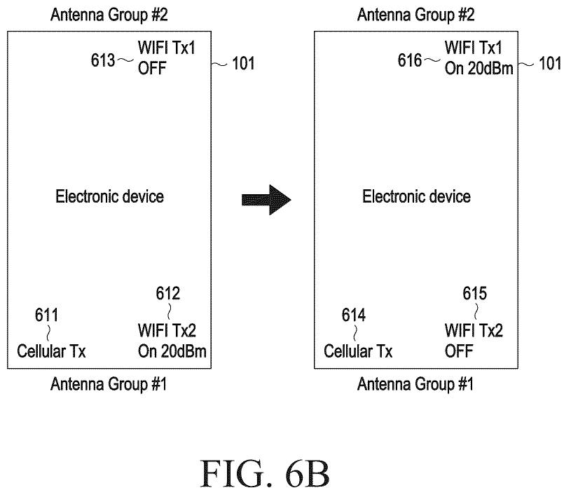

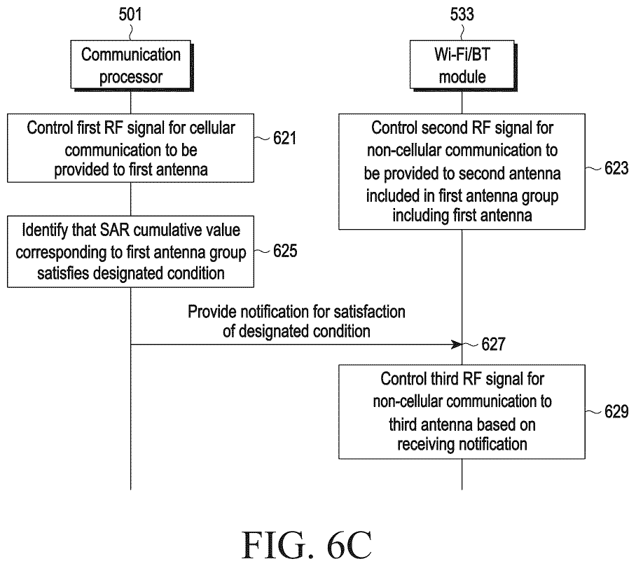

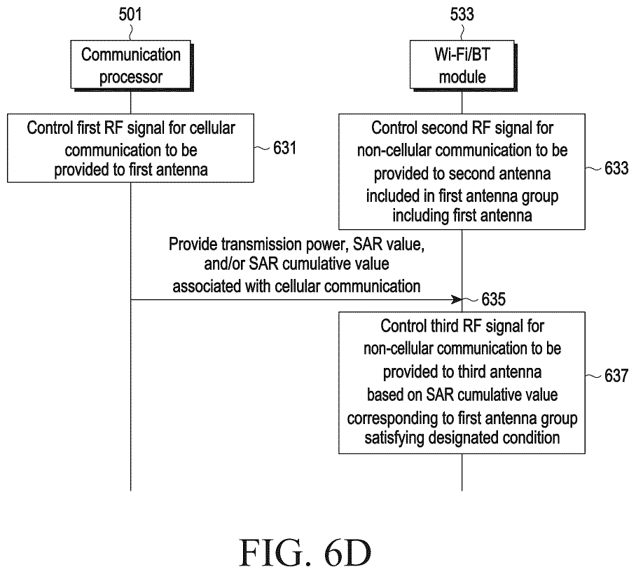

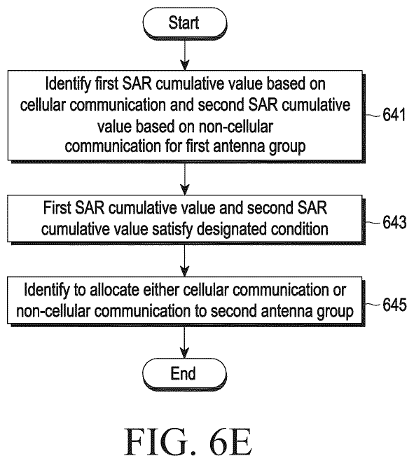

FIG. 6A is a flowchart illustrating an operation method of an electronic device according to an embodiment.

According to an embodiment, the communication processor 501 may control, in operation 601, a first RF signal for cellular communication to be provided to a first antenna included in a first antenna group, for example. The Wi-Fi/BT module 533 (which may also be referred to as at least one short-range communication module) may control, in operation 603, a second RF signal for non-cellular communication (e.g., Wi-Fi communication and/or Bluetooth communication) to be provided to a second antenna included in the first antenna group including the first antenna. For example, the Wi-Fi/BT module 533 may include an element for processing (which may be, e.g., a processor, MCU, or FPGA, but there is no limitation). In this case, operation 603 and/or other operations may be performed by the element for processing. Alternatively, the Wi-Fi/BT module 533 may perform operation 603 and/or other operations based on control of the application processor 531, and there is no limitation on the type and/or number of entities associated with the execution. Accordingly, whether to back off the first antenna group may be determined based on a SAR cumulative value of cellular communication and a SAR cumulative value of non-cellular communication for the first antenna group.

According to an embodiment, the communication processor 501 may determine, in operation 605, that a third RF signal for non-cellular communication is provided to a third antenna included in a second antenna group different from the first antenna group, based on identifying that a SAR cumulative value corresponding to the first antenna group satisfies a designated condition. In an example, the communication processor 501 may identify that the SAR cumulative value corresponding to the first antenna group is equal to or greater than a threshold cumulative value as satisfaction of the designated condition. In an example, the communication processor 501 may identify occurrence of back-off in the first antenna group as satisfaction of the designated condition, but there is no limitation on the designated condition. For example, the communication processor 501 may determine transmission power of an RF signal for non-cellular communication and notify the Wi-Fi/BT module 533, so that the communication processor 501 may identify a SAR value based on non-cellular communication and may manage a SAR cumulative value corresponding to the first antenna group using this. For example, the communication processor 501 may receive a report of transmission power and/or SAR value from the Wi-Fi/BT module 533, and may identify a SAR value based on non-cellular communication based thereon, and may manage a SAR cumulative value corresponding to the first antenna group using this, but there is no limitation on the method of identifying the SAR cumulative value. When the third RF signal for non-cellular communication is provided to the third antenna included in the second antenna group different from the first antenna group, only the SAR value corresponding to cellular communication may be reflected in the SAR cumulative value corresponding to the first antenna group in the first antenna group.

According to an embodiment, the communication processor 501 may provide, in operation 607, a control signal causing the third RF signal for non-cellular communication to be provided to the third antenna to the Wi-Fi/BT module 533. The control signal may include information indicating antenna change and/or information for identifying an antenna, but there is no limitation on the implementation method. The “change” of an antenna here may be referred to as, e.g., switching or hopping, and there is no limitation on the change method. The Wi-Fi/BT module 533 may control, in operation 609, the third RF signal for non-cellular communication to be provided to the third antenna. As the third RF signal for non-cellular communication is provided to the third antenna included in the second antenna group different from the first antenna group, only the SAR value corresponding to cellular communication may be reflected in the SAR cumulative value corresponding to the first antenna group in the first antenna group. Accordingly, the back-off period in the first antenna group may be decreased, the maximum value of transmission power backed off may be increased, and/or back-off may be prevented.

For example, the Wi-Fi/BT module 533 may change the transmission antenna change and/or settings associated with the number of transmission antennas (e.g., 1TX or 2TX) (which may be, e.g., 1TX, SISO, diversity, MIMO, but there is no limitation) when using Wi-Fi direct, Wi-Fi hot spot, and/or Bluetooth communication. For example, antenna change (e.g., TX hopping or antenna switching) may not be supported for cellular communication (or band and/or RAT), or although antenna change is supported, the transmission antenna of cellular communication may not be changed, but this is exemplary and there is no limitation.

FIG. 6B is a view illustrating transmission antenna change of an electronic device according to an embodiment.

According to an embodiment, the electronic device 101 may provide an RF signal 611 for cellular communication to a cellular transmission antenna disposed on one side of the lower side or lower portion. The electronic device 101 may provide an RF signal 612 for Wi-Fi communication to a second Wi-Fi transmission antenna disposed on another side of the lower side or lower portion. For example, the maximum transmission power value of the Wi-Fi transmission RF signal may be 20 dBm. Meanwhile, the electronic device 101 may deactivate 613 an RF path corresponding to a first Wi-Fi transmission antenna disposed on one side of the upper side or upper portion. For example, the second Wi-Fi transmission antenna may be a default transmission antenna for Wi-Fi communication, but this is exemplary and there is no limitation on the initial selection method of the second Wi-Fi transmission antenna. The SAR value for cellular communication and the SAR value for Wi-Fi communication may be accumulated, and a SAR cumulative value corresponding to the first antenna group corresponding to the lower side may be identified and/or managed.

According to an embodiment, the electronic device 101 may identify that the SAR cumulative value corresponding to the first antenna group satisfies a designated condition. For example, the electronic device 101 may identify that the SAR cumulative value corresponding to the first antenna group is equal to or greater than a designated threshold cumulative value. For example, the electronic device 101 may identify that the SAR cumulative value corresponding to the first antenna group satisfies a back-off condition, but there is no limitation. The electronic device 101 may deactivate 615 an RF path corresponding to the second Wi-Fi transmission antenna based on satisfaction of the designated condition, and may provide an RF signal 616 for Wi-Fi communication to the first Wi-Fi transmission antenna included in the second antenna group different from the first antenna group. For example, the maximum transmission power value of the Wi-Fi transmission RF signal may be 20 dBm, but there is no limitation on the value. The electronic device 101 may apply an RF signal 614 for cellular communication to the cellular transmission antenna of the first antenna group. As the transmission antenna for Wi-Fi communication is changed from the second antenna to the third antenna, the SAR value corresponding to cellular communication may be accumulated in the first antenna group, and the SAR value corresponding to Wi-Fi communication may be accumulated in the second antenna group. Accordingly, the back-off period in the first antenna group may be decreased, the maximum value of transmission power backed off may be increased, and/or back-off may be prevented.

FIG. 6C is a flowchart illustrating an operation method of an electronic device according to an embodiment.

According to an embodiment, the communication processor 501 may control, in operation 621, a first RF signal for cellular communication to be provided to a first antenna. The Wi-Fi/BT module 533 (which may also be referred to as at least one short-range communication module) may control, in operation 623, a second RF signal for non-cellular communication (e.g., Wi-Fi communication and/or Bluetooth communication) to be provided to a second antenna included in the first antenna group including the first antenna. Accordingly, whether to back off the first antenna group may be determined based on a SAR cumulative value of cellular communication and a SAR cumulative value of non-cellular communication for the first antenna group. The communication processor 501 may identify, in operation 625, that a SAR cumulative value corresponding to the first antenna group satisfies a designated condition. The communication processor 501 may provide, in operation 627, a notification about satisfaction of the designated condition to the Wi-Fi/BT module 533. The communication processor 501 may control, based on receiving the notification, a third RF signal for non-cellular communication to be provided to a third antenna included in the second antenna group.

FIG. 6D is a flowchart illustrating an operation method of an electronic device according to an embodiment.

According to an embodiment, the communication processor 501 may control, in operation 631, a first RF signal for cellular communication to be provided to a first antenna. The Wi-Fi/BT module 533 (which may also be referred to as at least one short-range communication module) may control, in operation 633, a second RF signal for non-cellular communication (e.g., Wi-Fi communication and/or Bluetooth communication) to be provided to a second antenna included in the first antenna group including the first antenna. The communication processor 501 may provide, in operation 635, transmission power, SAR value, and/or SAR cumulative value (or information corresponding to the values) associated with cellular communication to the Wi-Fi/BT module 533. The Wi-Fi/BT module 533 may control, in operation 637, a third RF signal for non-cellular communication to be provided to a third antenna included in a second antenna group different from the first antenna group, based on identifying that a SAR cumulative value corresponding to the first antenna group satisfies a designated condition. The Wi-Fi/BT module 533 may identify a SAR cumulative value corresponding to non-cellular communication. Further, the Wi-Fi/BT module 533 may identify a SAR cumulative value corresponding to cellular communication based on information received from the communication processor 501. Accordingly, the Wi-Fi/BT module 533 may identify a SAR cumulative value corresponding to the first antenna group by summing the SAR cumulative value corresponding to non-cellular communication and the SAR cumulative value corresponding to cellular communication. The Wi-Fi/BT module 533 may identify that the identified SAR cumulative value corresponding to the first antenna group satisfies a designated condition. Accordingly, the Wi-Fi/BT module 533 may control the third RF signal for non-cellular communication to be provided to the third antenna included in the second antenna group different from the first antenna group.

FIG. 6E is a flowchart illustrating an operation method of an electronic device according to an embodiment.

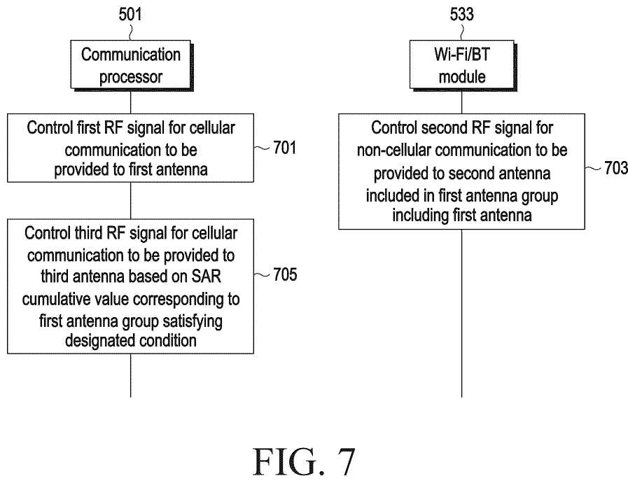

According to an embodiment, the electronic device 101 (e.g., the communication processor 501 and/or the Wi-Fi/BT module 533) may identify, in operation 641, a first SAR cumulative value based on cellular communication and a second SAR cumulative value based on non-cellular communication for the first antenna group. The electronic device 101 may identify, in operation 643, whether the first SAR cumulative value and the second SAR cumulative value satisfy a designated condition. In an example, the electronic device 101 may identify that the SAR cumulative value corresponding to the first antenna group is equal to or greater than a threshold cumulative value as satisfaction of the designated condition. In an example, the electronic device 101 may identify occurrence of back-off in the first antenna group as satisfaction of the designated condition, but there is no limitation on the designated condition. The electronic device 101 may identify, in operation 645, to allocate either cellular communication or non-cellular communication to the second antenna group. As described above, the electronic device 101 may allocate non-cellular communication to the second antenna group, but according to implementation, may also allocate cellular communication to the second antenna group, which is described with reference to FIG. 7. As either cellular communication or non-cellular communication is allocated to the second antenna group, cellular communication and non-cellular communication may be allocated to each of the different antenna groups.

FIG. 7 is a flowchart illustrating an operation method of an electronic device according to an embodiment.

According to an embodiment, the communication processor 501 may control, in operation 701, a first RF signal for cellular communication to be provided to a first antenna. The Wi-Fi/BT module 533 (which may also be referred to as at least one short-range communication module) may control, in operation 703, a second RF signal for non-cellular communication (e.g., Wi-Fi communication and/or Bluetooth communication) to be provided to a second antenna included in the first antenna group including the first antenna. Accordingly, whether to back off the first antenna group may be determined based on a SAR cumulative value of cellular communication and a SAR cumulative value of non-cellular communication for the first antenna group. The communication processor 501 may control, in operation 705, a third RF signal for cellular communication to be provided to a third antenna included in a second antenna group different from the first antenna group, based on identifying that a SAR cumulative value corresponding to the first antenna group satisfies a designated condition. Accordingly, the SAR value corresponding to non-cellular communication may be accumulated in the first antenna group, the SAR value corresponding to cellular communication may be accumulated in the second antenna group, and the back-off period in the first antenna group may be decreased, the maximum value of transmission power backed off may be increased, and/or back-off may be prevented.

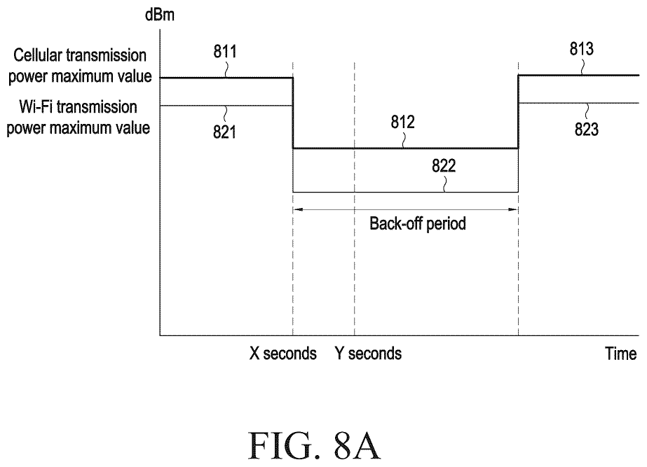

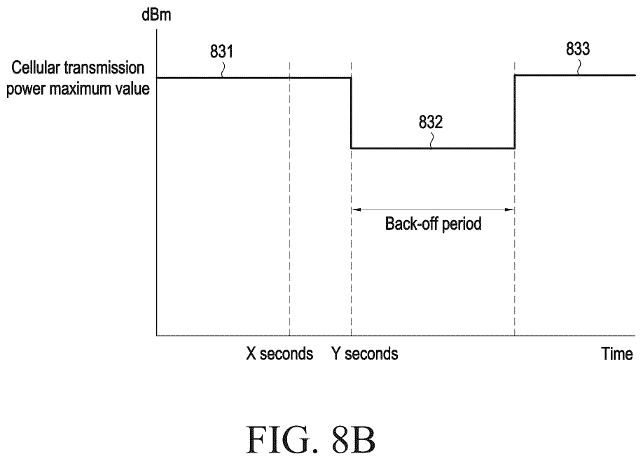

FIG. 8A is a view illustrating a maximum cellular transmission power value and a maximum Wi-Fi transmission power value for comparison with an embodiment. FIG. 8B is a view illustrating a maximum cellular transmission power value and a maximum Wi-Fi transmission power value according to an embodiment. Those skilled in the art will understand that at least some of the operations performed by the comparative example may also be performed by the embodiment of the disclosure.

The electronic device 101 may allocate, e.g., a first antenna for cellular communication and may allocate a second antenna for non-cellular communication, e.g., Wi-Fi communication, and the first antenna and the second antenna may be included in the same antenna group. The electronic device 101 may set the maximum cellular transmission power value to a first value 811 and may set the maximum Wi-Fi transmission power value to a second value 821 during a first period (e.g., before X seconds). The electronic device 101 may set cellular transmission power equal to or less than the maximum cellular transmission power value and may set Wi-Fi transmission power equal to or less than the maximum Wi-Fi transmission power value. The electronic device 101 may identify SAR values generated based on the cellular transmission power and the Wi-Fi transmission power. The electronic device 101 may identify a SAR cumulative value corresponding to the first antenna group based on SAR values generated based on the cellular transmission power and the Wi-Fi transmission power. Based on the SAR cumulative value satisfying a back-off condition, the electronic device 101 may perform back-off at the time of “X seconds”. In FIG. 8A, although it is illustrated that back-off is performed for both communications at the time of “X seconds”, this is exemplary and back-off may be performed for only one of the two communications. For example, back-off may be performed sequentially for the communications, and there is no limitation on the order of back-off. The electronic device 101 may perform back-off for both communications, and accordingly may set the maximum cellular transmission power value to a third value 812 and may set the maximum Wi-Fi transmission power value to a fourth value 822. After the back-off period elapses, the SAR cumulative value for the first antenna group may decrease. Accordingly, the electronic device 101 may stop back-off and may set the maximum cellular transmission power value to the first value 813 and may set the maximum Wi-Fi transmission power value to the second value 823.

Meanwhile, referring to FIG. 8B, the electronic device 101 according to an embodiment may allocate, e.g., a first antenna for cellular communication and may allocate a second antenna for non-cellular communication, e.g., Wi-Fi communication, and the first antenna and the second antenna may be included in the same antenna group. The electronic device 101 may identify that a SAR cumulative value corresponding to the first antenna group satisfies a designated condition for antenna change, e.g., before a back-off condition is performed. Based on satisfaction of the designated condition, the electronic device 101 may allocate Wi-Fi communication to the second antenna group. Accordingly, in FIG. 8B, maximum cellular transmission power values 831, 832, 833 may be illustrated. For example, during a second period (e.g., before Y seconds), the maximum cellular transmission power value may be set to a first value 831. During the second period, the SAR cumulative value corresponding to the first antenna group may increase, and accordingly, at “Y seconds”, the electronic device 101 may identify that a back-off condition is satisfied. However, when compared with the comparative example of FIG. 8A, the time of back-off may be delayed from “X seconds” to “Y seconds”, and the back-off period in FIG. 8B may be shorter than the back-off period in FIG. 8A. According to the back-off operation, the electronic device 101 may set the maximum cellular transmission power value to a second value 832. After the back-off period elapses, the SAR cumulative value for the first antenna group may decrease. Accordingly, the electronic device 101 may stop back-off and may set the maximum cellular transmission power value to a third value 833.

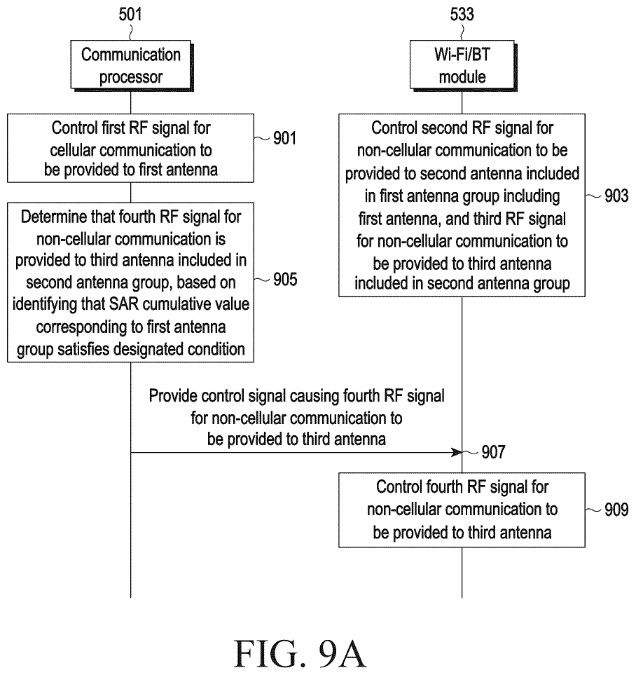

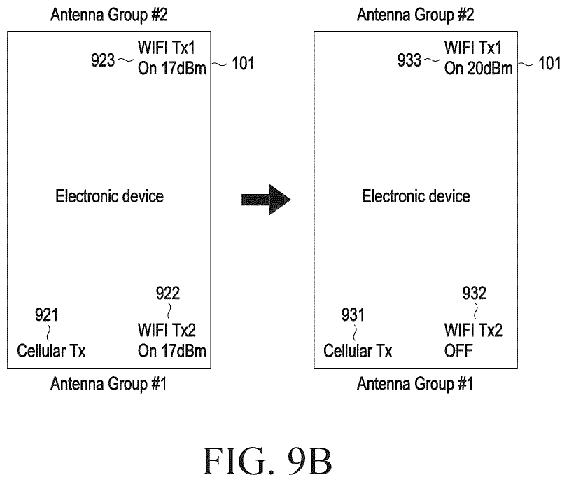

FIG. 9A illustrates a flowchart for describing an operation method of an electronic device according to an embodiment.

According to an embodiment, the communication processor 501 may control, in operation 901, a first RF signal for cellular communication to be provided to a first antenna. The Wi-Fi/BT module 533 (which may also be referred to as at least one short-range communication module) may control, in operation 903, a second RF signal for non-cellular communication (e.g., Wi-Fi communication and/or Bluetooth communication) to be provided to a second antenna included in the first antenna group including the first antenna, and a third RF signal for non-cellular communication to be provided to a third antenna included in the second antenna group. For example, the Wi-Fi/BT module 533 may perform a 2TX-based operation (e.g., MIMO or diversity) and may control each of the two RF signals based on 2TX to be applied to the second antenna and the third antenna, respectively. Accordingly, whether to back off the first antenna group may be determined based on a SAR cumulative value of cellular communication and a SAR cumulative value corresponding to one of the two RF signals of non-cellular communication for the first antenna group. Meanwhile, whether to back off the second antenna group may be determined based on a SAR cumulative value corresponding to the other one of the two RF signals of non-cellular communication for the second antenna group.

According to an embodiment, the communication processor 501 may determine, in operation 905, that a fourth RF signal for non-cellular communication is provided to the third antenna included in the second antenna group different from the first antenna group, based on identifying that a SAR cumulative value corresponding to the first antenna group satisfies a designated condition. In an example, the communication processor 501 may identify that the SAR cumulative value corresponding to the first antenna group is equal to or greater than a threshold cumulative value as satisfaction of the designated condition. In an example, the communication processor 501 may identify occurrence of back-off in the first antenna group as satisfaction of the designated condition, but there is no limitation on the designated condition.

According to an embodiment, the communication processor 501 may provide, in operation 907, a control signal causing the fourth RF signal for non-cellular communication to be provided to the third antenna to the Wi-Fi/BT module 533. The control signal may include information indicating antenna change and/or information for identifying an antenna, but there is no limitation on the implementation method. The “change” of an antenna here may mean changing a 2TX-based operation (e.g., MIMO or diversity) to a 1TX-based operation (which may be, e.g., referred to as SISO, but there is no limitation). The Wi-Fi/BT module 533 may control, in operation 909, the fourth RF signal for non-cellular communication to be provided to the third antenna. For example, the Wi-Fi/BT module 533 may stop the 2TX operation of non-cellular communication and may perform a 1TX operation, and may determine the transmission antenna for the 1TX operation as the third antenna included in the second antenna group. As the fourth RF signal for non-cellular communication is provided to the third antenna included in the second antenna group different from the first antenna group, only the SAR value corresponding to cellular communication may be reflected in the SAR cumulative value corresponding to the first antenna group in the first antenna group. Accordingly, the back-off period in the first antenna group may be decreased, the maximum value of transmission power backed off may be increased, and/or back-off may be prevented.

FIG. 9B is a view illustrating transmission antenna change of an electronic device according to an embodiment.

According to an embodiment, the electronic device 101 may provide an RF signal 921 for cellular communication to a cellular transmission antenna disposed on one side of the lower side or lower portion. The electronic device 101 may perform a 2TX operation (e.g., MIMO or diversity) for non-cellular communication. For example, the electronic device 101 may provide an RF signal 922 for Wi-Fi communication to a second Wi-Fi transmission antenna disposed on another side of the lower side or lower portion. The electronic device 101 may provide an RF signal 923 for Wi-Fi communication to a first Wi-Fi transmission antenna disposed on an upper side. For example, the maximum transmission power value of the Wi-Fi transmission RF signal may be 17 dBm. For example, the maximum transmission power value during the 2TX operation may be set smaller than the maximum transmission power value (e.g., 20 dBm) during the 1TX operation by a designated size (e.g., 3 dB), but there is no limitation. The SAR value for cellular communication and the SAR value for Wi-Fi communication may be accumulated, and a SAR cumulative value corresponding to the first antenna group corresponding to the lower side may be identified and/or managed. The SAR value for Wi-Fi communication may be accumulated, and a SAR cumulative value corresponding to the second antenna group corresponding to the upper side may be identified and/or managed.

According to an embodiment, the electronic device 101 may identify that the SAR cumulative value corresponding to the first antenna group satisfies a designated condition. For example, the electronic device 101 may identify that the SAR cumulative value corresponding to the first antenna group is equal to or greater than a designated threshold cumulative value. For example, the electronic device 101 may identify that the SAR cumulative value corresponding to the first antenna group satisfies a back-off condition, but there is no limitation. The electronic device 101 may deactivate 932 an RF path corresponding to the second Wi-Fi transmission antenna based on satisfaction of the designated condition and may perform a 1TX operation for non-cellular communication. Accordingly, the electronic device 101 may provide an RF signal 933 for Wi-Fi communication to the first Wi-Fi transmission antenna included in the second antenna group different from the first antenna group. For example, the maximum transmission power value of the RF signal 933 corresponding to the 1TX operation may be set to 20 dBm, which is larger than the maximum transmission power value (e.g., 17 dBm) of the RF signals 922, 923 corresponding to the 2TX operation by a designated size (e.g., 3 dB), but this is exemplary and there is no limitation on the setting method. The electronic device 101 may apply an RF signal 931 for cellular communication to the cellular transmission antenna of the first antenna group. As non-cellular communication operates based on 1TX, the SAR value corresponding to cellular communication may be accumulated in the first antenna group, and the SAR value corresponding to Wi-Fi communication may be accumulated in the second antenna group. Accordingly, the back-off period in the first antenna group may be decreased, the maximum value of transmission power backed off may be increased, and/or back-off may be prevented.

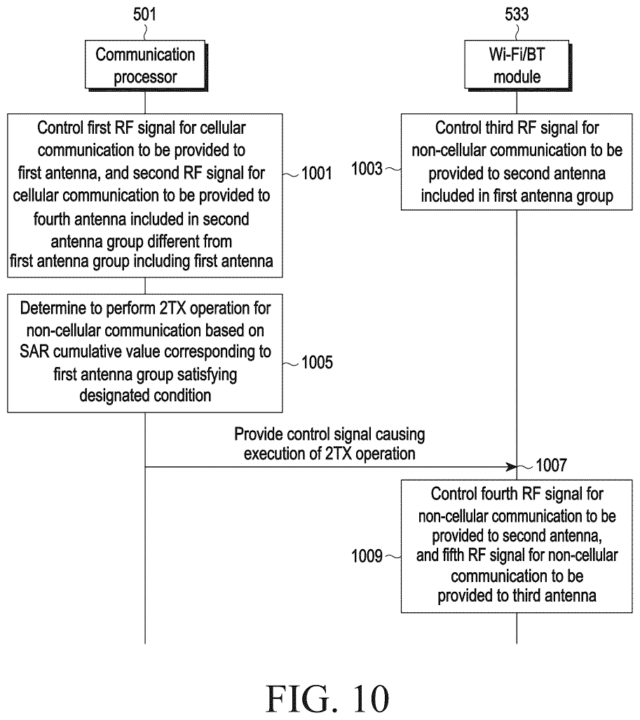

FIG. 10 is a flowchart illustrating an operation method of an electronic device according to an embodiment.

According to an embodiment, the communication processor 501 may control, in operation 1001, a first RF signal for cellular communication to be provided to a first antenna and a second RF signal for cellular communication to be provided to a fourth antenna included in a second antenna group different from the first antenna group including the first antenna. The Wi-Fi/BT module 533 (which may also be referred to as at least one short-range communication module) may control, in operation 1003, a third RF signal for non-cellular communication (e.g., Wi-Fi communication and/or Bluetooth communication) to be provided to a second antenna included in the first antenna group including the first antenna. For example, non-cellular communication may operate based on 1TX. Accordingly, whether to back off the first antenna group may be determined based on a SAR cumulative value of cellular communication and a SAR cumulative value corresponding to non-cellular communication for the first antenna group. Meanwhile, whether to back off the second antenna group may be determined based on a SAR cumulative value corresponding to cellular communication for the second antenna group.

According to an embodiment, the communication processor 501 may determine, in operation 1005, to perform a 2TX operation for non-cellular communication, based on identifying that a SAR cumulative value corresponding to the first antenna group satisfies a designated condition. The communication processor 501 may provide, in operation 1007, a control signal causing performance of the 2TX operation to the Wi-Fi/BT module 533. The Wi-Fi/BT module 533 may perform, in operation 1009, a 2TX operation that controls a fourth RF signal for non-cellular communication to be provided to the second antenna and a fifth RF signal for non-cellular communication to be provided to the third antenna. For example, the maximum value of transmission power of both RF signals during the 2TX operation may be set smaller than the maximum value of transmission power of the RF signal during the 1TX operation by a designated size (e.g., 3 dB). Accordingly, the maximum value of transmission power corresponding to the second antenna included in the first antenna group may decrease from, e.g., 20 dBm to 17 dBm. According to the decrease in the maximum value of transmission power, the SAR value corresponding to the second antenna may decrease, and accordingly, the back-off period in the first antenna group may be decreased, the maximum value of transmission power backed off may be increased, and/or back-off may be prevented.

For example, the communication processor 501 may determine whether to switch from the 1TX operation to the 2TX operation as in FIG. 10 or to perform antenna change as in FIG. 6A, based on a SAR cumulative value previously generated in the second antenna group and/or whether cellular communication is activated in the second antenna group. For example, when the SAR cumulative value previously generated in the second antenna group is relatively large, the possibility that back-off occurs in the second antenna group due to antenna change may also be relatively high. Accordingly, e.g., the communication processor 501 may perform switching to the 2TX operation for non-cellular communication as in FIG. 10, based on the SAR cumulative value previously generated in the second antenna group being equal to or greater than a threshold cumulative value (which may be different from the threshold cumulative value for antenna change described above, but may be the same according to implementation). If the SAR cumulative value previously generated in the second antenna group is less than the threshold cumulative value, the communication processor 501 may perform transmission antenna change for non-cellular communication as in FIG. 6A. In this case, even when a relatively large SAR value is accumulated in the second antenna group based on the transmission antenna change, the possibility that the back-off condition in the second antenna group is satisfied is relatively low.

For example, when cellular communication is activated in the second antenna group, the possibility that back-off occurs in the second antenna group due to antenna change may also be relatively high. Accordingly, e.g., the communication processor 501 may perform switching to the 2TX operation for non-cellular communication as in FIG. 10, based on cellular communication being activated in the second antenna group. When cellular communication is deactivated in the second antenna group, the communication processor 501 may perform transmission antenna change for non-cellular communication as in FIG. 6A. In this case, even when a relatively large SAR value is accumulated in the second antenna group based on the transmission antenna change, since cellular communication is deactivated, the possibility that the back-off condition in the second antenna group is satisfied is relatively low.

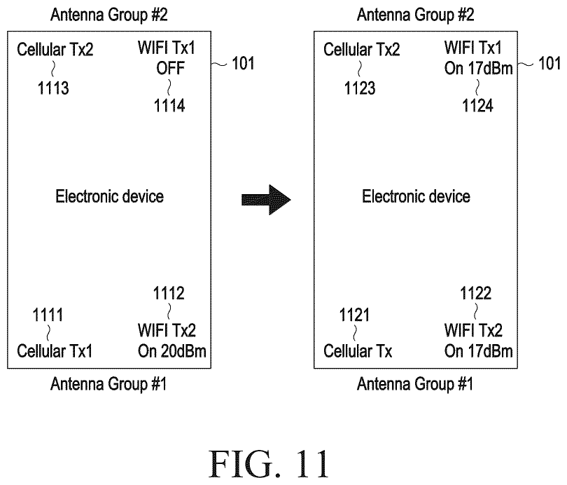

FIG. 11 is a view illustrating transmission antenna change of an electronic device according to an embodiment.

According to an embodiment, the electronic device 101 may provide an RF signal 1111 for cellular communication to a first cellular transmission antenna disposed on one side of the lower side or lower portion and may provide an RF signal 1113 for cellular communication to a second cellular transmission antenna disposed on one side of the upper side or upper portion. The electronic device 101 may perform a 1TX operation for non-cellular communication. For example, the electronic device 101 may provide an RF signal 1112 for Wi-Fi communication to a second Wi-Fi transmission antenna disposed on another side of the lower side or lower portion. For example, the maximum transmission power value of the Wi-Fi transmission RF signal for the 1TX operation may be 20 dBm. According to the 1TX operation of non-cellular communication, an RF path corresponding to a first Wi-Fi transmission antenna disposed on another side of the upper side or upper portion may be deactivated 1114. The SAR value for cellular communication and the SAR value for Wi-Fi communication may be accumulated, and a SAR cumulative value corresponding to the first antenna group corresponding to the lower side may be identified and/or managed. The SAR value for cellular communication may be accumulated, and a SAR cumulative value corresponding to the second antenna group corresponding to the upper side may be identified and/or managed.

According to an embodiment, the electronic device 101 may identify that the SAR cumulative value corresponding to the first antenna group satisfies a designated condition. For example, the electronic device 101 may identify that the SAR cumulative value corresponding to the first antenna group is equal to or greater than a designated threshold cumulative value. For example, the electronic device 101 may identify that the SAR cumulative value corresponding to the first antenna group satisfies a back-off condition, but there is no limitation. The electronic device 101 may determine to perform a 2TX operation for non-cellular communication based on satisfaction of the designated condition. For example, the electronic device 101 may perform a 2TX operation that applies an RF signal 1124 to the first Wi-Fi transmission antenna and provides an RF signal 1122 to the second Wi-Fi transmission antenna. For example, the maximum transmission power value during the 2TX operation may be set smaller than the maximum transmission power value (e.g., 20 dBm) during the 1TX operation by a designated size (e.g., 3 dB), but there is no limitation. The electronic device 101 may apply RF signals 1121, 1123 to the cellular communication antennas.

As described above, the maximum transmission power value (e.g., 17 dBm) corresponding to the 2TX operation may be set smaller than the maximum transmission power value (e.g., 20 dBm) corresponding to the 1TX operation. The SAR value corresponding to non-cellular communication in the first antenna group that occurs during the 2TX operation may be smaller than the SAR value corresponding to non-cellular communication in the first antenna group that occurs during the 1TX operation. Accordingly, the back-off period in the first antenna group may be decreased, the maximum value of transmission power backed off may be increased, and/or back-off may be prevented.

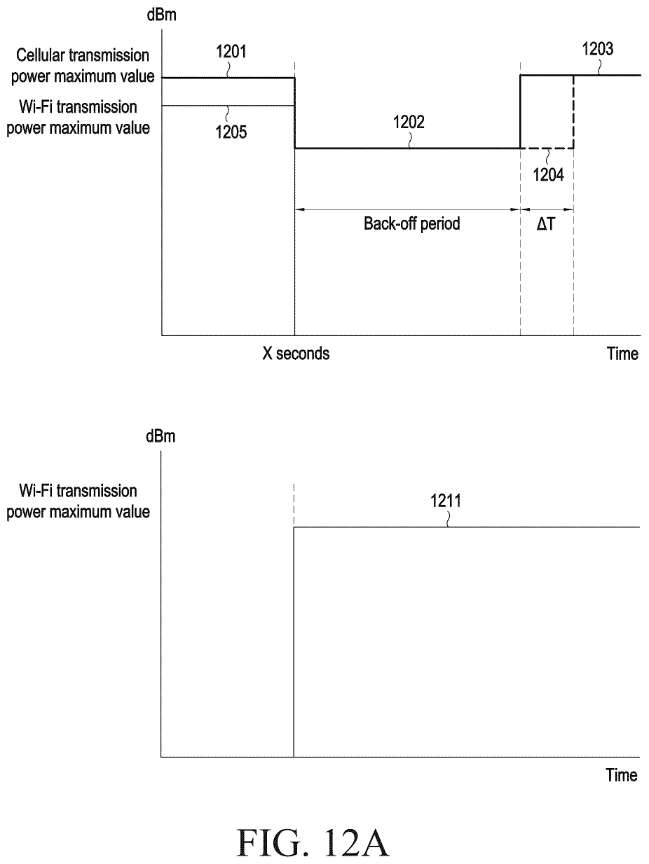

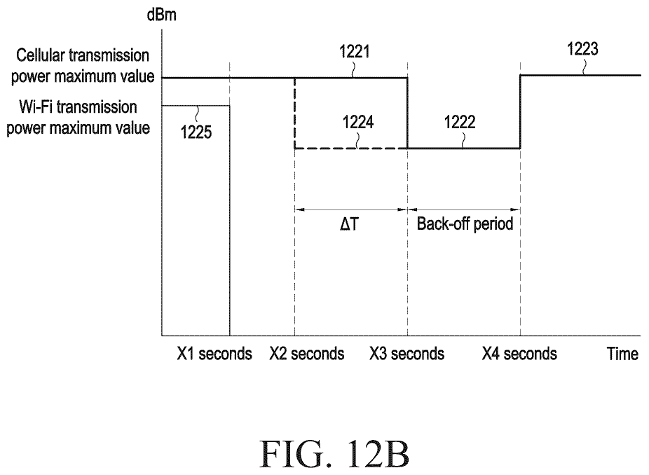

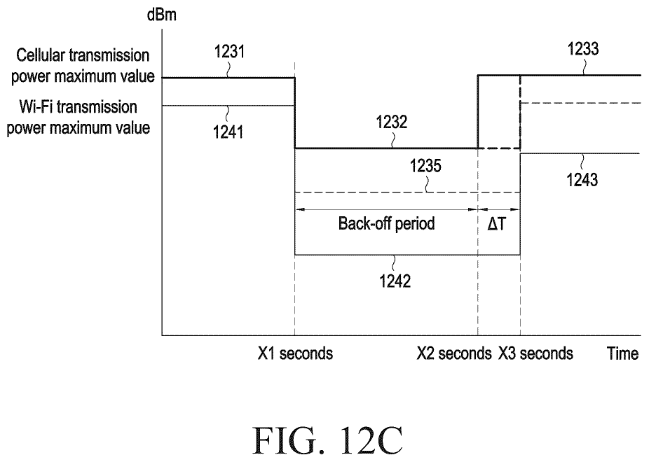

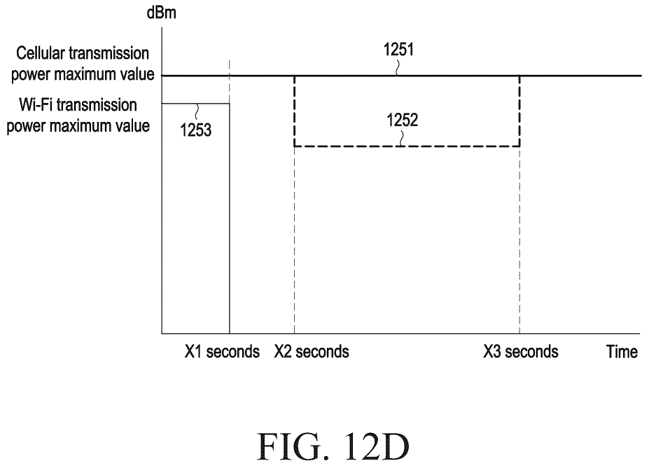

FIG. 12A is a view illustrating reduction of a back-off period according to an embodiment.

The upper side of FIG. 12A may be a graph for the first antenna group, and the lower side of FIG. 12B may be a graph for the second antenna group. According to an embodiment, the electronic device 101 may allocate cellular communication and non-cellular communication, e.g., Wi-Fi communication, to the first antenna group. In the embodiment of FIG. 12A, it is assumed that the electronic device 101 does not allocate any communication to the second antenna group at the initial time. For example, the maximum cellular transmission power value of the first antenna group may be a first value 1201, and the maximum cellular transmission power value of the first antenna group may be a second value 1205. Meanwhile, the electronic device 101 may identify satisfaction of a designated condition of a SAR cumulative value corresponding to the first antenna group at the time of “X seconds”. The electronic device 101 may identify satisfaction of a back-off condition, e.g., and accordingly may perform back-off for cellular communication. As described with reference to FIG. 6A, the electronic device 101 may allocate Wi-Fi communication, which is non-cellular communication, to the second antenna group based on satisfaction of the designated condition (e.g., back-off condition). Accordingly, in the graph of the first antenna group, only maximum values of cellular transmission power may be illustrated after “X seconds”, and in the graph of the second antenna group, it may be identified that the maximum Wi-Fi transmission power value is set after “X seconds”. The maximum cellular transmission power value backed off may be a third value 1202. The maximum Wi-Fi transmission power value in the second antenna group may be a second value 1211, but according to implementation, a value different from the second value 1221 in the first antenna group may be set. As only cellular communication is allocated in the first antenna group, the SAR cumulative value within a constant time window during the back-off period may decrease. Accordingly, after the back-off period elapses, the electronic device 101 may restore the maximum cellular transmission power value back to the first value 1203. Meanwhile, if transmission antenna change for non-cellular communication had not been performed, the maximum transmission power value 1204 backed off would have been maintained by ΔT. Accordingly, it may be identified that the back-off period is decreased according to the transmission antenna change. Meanwhile, according to implementation, the electronic device 101 may not only restore the maximum value of cellular transmission power as in FIG. 12A, but may additionally reallocate non-cellular communication to the first antenna group based on resolution of the back-off condition, and there is no limitation.

FIG. 12B is a view illustrating reduction of a back-off period according to an embodiment.

According to an embodiment, the electronic device 101 may allocate cellular communication and non-cellular communication, e.g., Wi-Fi communication, to the first antenna group. For example, the maximum cellular transmission power value of the first antenna group may be a first value 1221, and the maximum cellular transmission power value of the first antenna group may be a second value 1225. Meanwhile, the electronic device 101 may identify satisfaction of a designated condition of a SAR cumulative value corresponding to the first antenna group at the time of “X1 seconds”. The designated condition may be, e.g., a condition where the SAR cumulative value is equal to or greater than a threshold cumulative value. The electronic device 101 may change the transmission antenna of Wi-Fi communication from an antenna included in the first antenna group to an antenna included in the second antenna group as in FIG. 6A. Accordingly, the maximum Wi-Fi transmission power value in the first antenna group of FIG. 12B may be 0 after “X1 seconds”. In FIG. 12A, if the change of the transmission antenna of non-cellular communication was performed after performing back-off based on satisfaction of the back-off condition, in FIG. 12B, the change of the transmission antenna of non-cellular communication may be performed before performing back-off.

Subsequently, the electronic device 101 may identify that the back-off condition of the first antenna group is satisfied at the time of “X3 seconds”. Accordingly, the electronic device 101 may set the maximum cellular transmission power value to a third value 1222. Meanwhile, if the transmission antenna change of non-cellular communication had not been performed, the back-off condition could have been satisfied at the time of “X2 seconds”, and the maximum transmission power value 1224 backed off might have needed to be set relatively early. However, as the transmission antenna change of non-cellular communication is performed, the back-off period may be shortened by ΔT. At “X4 seconds” after the back-off period elapses, the electronic device 101 may restore the maximum cellular transmission power value back to the first value 1223. Meanwhile, according to implementation, the electronic device 101 may not only restore the maximum value of cellular transmission power as in FIG. 12B, but may additionally reallocate non-cellular communication to the first antenna group based on resolution of the back-off condition, and there is no limitation.

FIG. 12C is a view illustrating reduction of a back-off period according to an embodiment.

According to an embodiment, the electronic device 101 may allocate cellular communication and non-cellular communication, e.g., Wi-Fi communication, to the first antenna group. For example, the maximum cellular transmission power value of the first antenna group may be a first value 1231, and the maximum cellular transmission power value of the first antenna group may be a second value 1241. Meanwhile, the electronic device 101 may identify satisfaction of a designated condition of a SAR cumulative value corresponding to the first antenna group at the time of “X1 seconds”. The designated condition may be, e.g., a back-off condition. Accordingly, the electronic device 101 may set the maximum cellular transmission power value to a third value 1232. The electronic device 101 may determine a 2TX operation of non-cellular communication as described in connection with FIG. 10. Accordingly, the maximum Wi-Fi transmission power value in the first antenna group may be set to a fifth value 1242 that is smaller than a fourth value 1235 corresponding to the 1TX operation by a designated value (e.g., 3 dB). The electronic device 101 may identify release of the back-off condition at “X2 seconds” and accordingly may restore the maximum transmission power values of both communications. The electronic device 101 may restore the maximum cellular transmission power value to the first value 1233. Meanwhile, the electronic device 101 may set the maximum Wi-Fi transmission power value to a sixth value 1243 that is smaller than the transmission power maximum value 1241 in 1TX by a designated size (e.g., 3 dB). Meanwhile, if the 2TX operation for non-cellular communication had not been performed and the performance of the 1TX operation had been maintained, the release time of the back-off condition would have been delayed by “X3 seconds”, and it may be identified that the back-off period may be shortened by ΔT.

FIG. 12D is a view illustrating back-off prevention according to an embodiment.

According to an embodiment, the electronic device 101 may allocate cellular communication and non-cellular communication, e.g., Wi-Fi communication, to the first antenna group. For example, the maximum cellular transmission power value of the first antenna group may be a first value 1251, and the maximum cellular transmission power value of the first antenna group may be a second value 1253. Meanwhile, the electronic device 101 may identify satisfaction of a designated condition of a SAR cumulative value corresponding to the first antenna group at the time of “X1 seconds”. The designated condition may be, e.g., a condition where the SAR cumulative value is equal to or greater than a threshold cumulative value. The electronic device 101 may change the transmission antenna of Wi-Fi communication from an antenna included in the first antenna group to an antenna included in the second antenna group as in FIG. 6A. Accordingly, the maximum Wi-Fi transmission power value in the first antenna group of FIG. 12D may be 0 after “X1 seconds”. Subsequently, since the SAR value generated per time unit in the first antenna group is set to only the SAR value corresponding to cellular communication, in some cases, the maximum cellular transmission power value may be maintained at the first value 1251 without back-off as in FIG. 12D. If the transmission antenna change for non-cellular communication had not been performed, the maximum cellular transmission power value could have been a second value 1252 between “X2 seconds” and “X3 seconds”, but according to the transmission antenna change for non-cellular communication, back-off for cellular communication may not be performed.

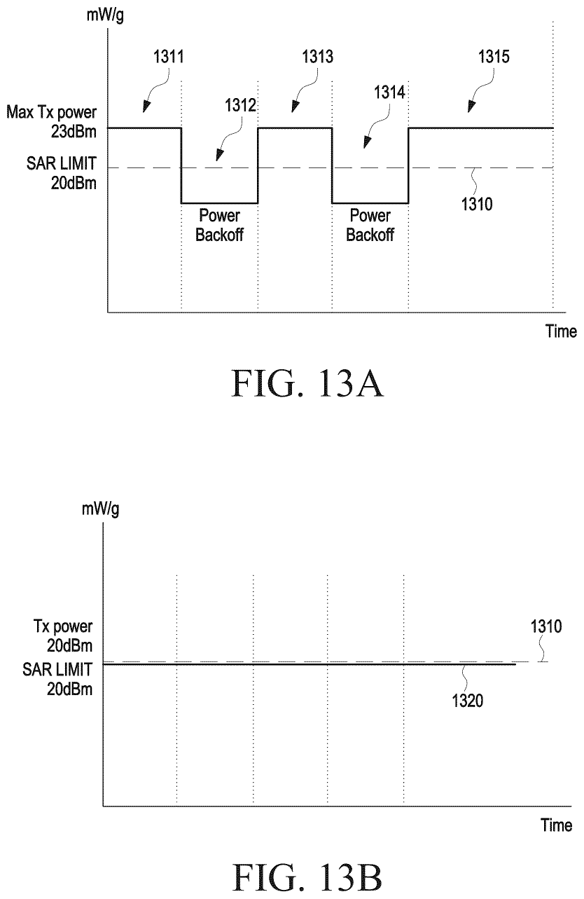

FIGS. 13A and 13B are views illustrating various transmission states according to embodiments.

Referring to FIG. 13A, according to an embodiment, the electronic device 101 may set a transmission state to a back-off state (which may also be referred to as a transmission power swing state). In the back-off state, e.g., as in FIG. 13A, the electronic device 101 may determine the maximum transmission power value of non-cellular communication based on first transmission power limits 1311, 1313, 1315. The electronic device 101 may determine to perform back-off according to an antenna group or a SAR margin allocated to the corresponding communication and a SAR cumulative value previously generated. For example, the maximum transmission power value 1310 corresponding to the SAR margin may be 20 dBm. As described above, in the back-off state, back-off of the maximum transmission power value (or transmission power) may be performed. For example, maximum transmission power values 1311, 1313, 1315 during periods when back-off is not required may be set, and maximum transmission power values 1312, 1314 backed off may be set during periods when the back-off condition is satisfied. When the transmission state is the back-off state, back-off for non-cellular communication may be performed.

Meanwhile, in the constant state, as in FIG. 13B, the electronic device 101 may set the limit of transmission power as a constant. For example, when the maximum transmission power value 1310 corresponding to the SAR margin allocated to an antenna group or one non-cellular communication (e.g., Bluetooth communication) is 20 dBm, the electronic device 101 may set the maximum value of transmission power to 20 dBm 1320 (or a smaller value). For example, in the case of a designated type (which may be, e.g., a hearing aid type, but there is no limitation), operation in the constant state may be required, but there is no limitation. Operations in the constant state of the transmission state are described below.

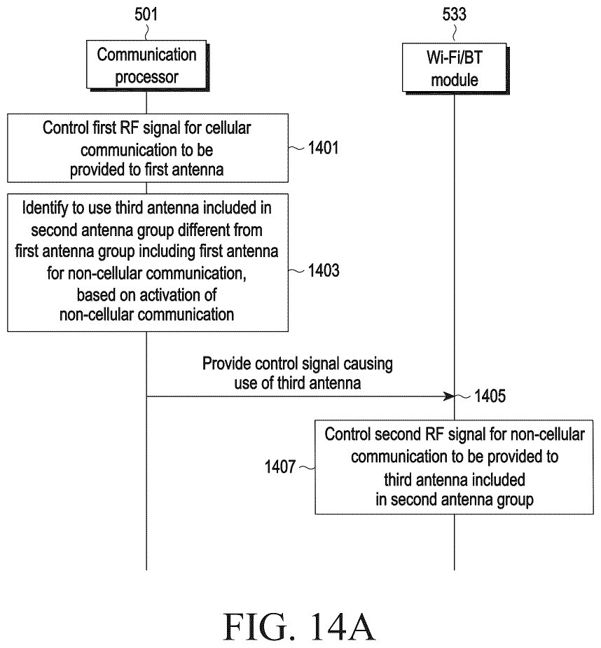

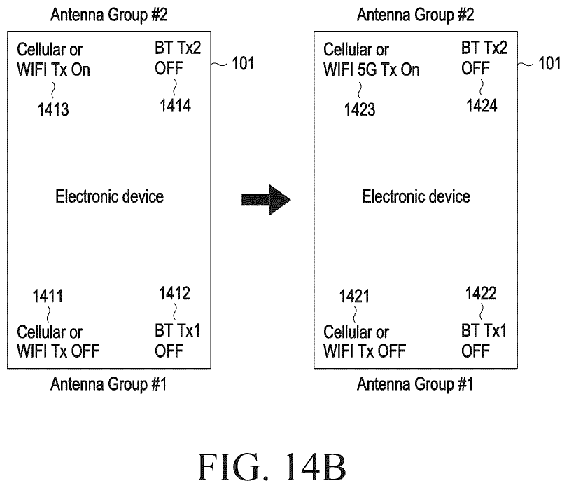

FIG. 14A is a flowchart illustrating an operation method of an electronic device according to an embodiment.

According to an embodiment, the communication processor 501 may control, in operation 1401, a first RF signal for cellular communication to be provided to a first antenna. Meanwhile, it is assumed that non-cellular communication is deactivated during this time. In operation 1403, the communication processor 501 may identify to use a third antenna included in a second antenna group different from the first antenna group including the first antenna for non-cellular communication, based on activation of non-cellular communication. The communication processor 501 may provide, in operation 1405, a control signal causing a second RF signal for non-cellular communication to be provided to the third antenna to the Wi-Fi/BT module 533. The control signal may include, e.g., information indicating default antenna change and/or information for identifying an antenna, but there is no limitation on the implementation method. The Wi-Fi/BT module 533 may control, in operation 1407, the second RF signal for non-cellular communication to be provided to the third antenna. As the second RF signal for non-cellular communication is provided to the third antenna included in the second antenna group different from the first antenna group, only the SAR value corresponding to cellular communication may be reflected in the SAR cumulative value corresponding to the first antenna group in the first antenna group. Accordingly, the back-off period in the first antenna group may be decreased, the maximum value of transmission power backed off may be increased, and/or back-off may be prevented.

FIG. 14B is a view illustrating transmission antenna change of an electronic device according to an embodiment.

According to an embodiment, the electronic device 101 may deactivate 1411 an RF path corresponding to a first cellular transmission antenna disposed on one side of the lower side or lower portion and may provide an RF signal 1413 for cellular communication to a second cellular transmission antenna disposed on one side of the upper side or upper portion. Meanwhile, Bluetooth communication, which is non-cellular communication, may be deactivated 1412, 1414. Subsequently, the electronic device 101 may identify activation of Bluetooth communication. In this case, the electronic device 101 may maintain deactivation 1424 of an RF path corresponding to a first Bluetooth transmission antenna included in the first antenna group including the first cellular transmission antenna, and may provide an RF signal 1422 for Bluetooth communication to a second Bluetooth transmission antenna included in the second antenna group disposed on another side of the lower side or lower portion. For example, deactivation 1421 of the RF path corresponding to the first cellular transmission antenna, activation 1423 of the RF path corresponding to the second cellular transmission antenna, and deactivation 1424 of the RF path corresponding to the second Bluetooth transmission antenna disposed on another side of the upper side or upper portion may be maintained. Accordingly, the SAR cumulative value in the first antenna group may be determined as the SAR value corresponding to Bluetooth communication, and the SAR cumulative value in the second antenna group may be determined as the SAR value corresponding to cellular communication. As one communication is allocated to both antenna groups, the back-off period may be decreased, the maximum value of transmission power backed off may be increased, and/or back-off may not be performed. Meanwhile, in an embodiment, those skilled in the art will understand that Wi-Fi communication (which may be, e.g., 5 GHz, but there is no limitation) may operate together with Bluetooth communication instead of cellular communication. For example, according to implementation, when the 2.4 GHz band of Wi-Fi communication is activated, since it overlaps the band of Bluetooth, only one of Wi-Fi communication or Bluetooth communication may use a transmission antenna, and the other communication may be deactivated, but there is no limitation. For example, when the 5 GHz band of Wi-Fi communication is activated, each of Wi-Fi communication and Bluetooth communication may use different transmission antennas, so both communications may be activated, but this is exemplary and there is no limitation.

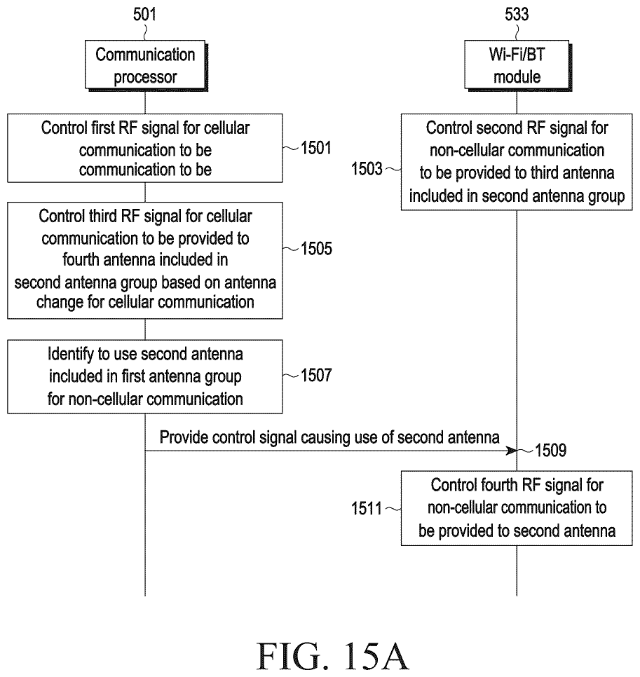

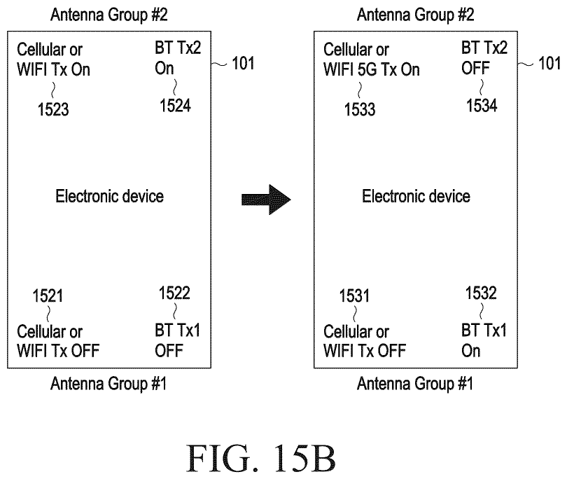

FIG. 15A is a flowchart illustrating an operation method of an electronic device according to an embodiment.

According to an embodiment, the communication processor 501 may control, in operation 1501, a first RF signal for cellular communication to be provided to a first antenna. The Wi-Fi/BT module 533 may control, in operation 1503, a second RF signal for non-cellular communication to be provided to a third antenna included in the second antenna group. For example, as described in connection with FIG. 14A, based on activation of Bluetooth communication, cellular communication and Bluetooth communication may each be allocated to different antenna groups. The communication processor 501 may control, in operation 1505, a third RF signal for cellular communication to be provided to a fourth antenna included in the second antenna group, based on antenna change for cellular communication (e.g., antenna switching or TX hopping). For example, the communication processor 501 may perform antenna change based on satisfaction of a condition for antenna switching or TX hopping (which may be, e.g., a condition set by the strength of cellular received signals of each antenna, but there is no limitation). In operation 1507, the communication processor 501 may identify to use a second antenna included in the first antenna group for non-cellular communication. As cellular communication is allocated to the second antenna group, the communication processor 501 may allocate non-cellular communication to the first antenna group. The communication processor 501 may provide, in operation 1509, a control signal causing use of the second antenna to the Wi-Fi/BT module 533. The Wi-Fi/BT module 533 may control, in operation 1511, a fourth RF signal for non-cellular communication to be provided to the second antenna included in the first antenna group. As the second RF signal for non-cellular communication is provided to the second antenna included in the first antenna group, only the SAR value corresponding to Bluetooth communication may be reflected in the SAR cumulative value corresponding to the first antenna group in the first antenna group. Accordingly, the back-off period in the first antenna group may be decreased, the maximum value of transmission power backed off may be increased, and/or back-off may be prevented.

FIG. 15B is a view illustrating transmission antenna change of an electronic device according to an embodiment.

According to an embodiment, the electronic device 101 may deactivate 1521 an RF path corresponding to a first cellular transmission antenna disposed on one side of the lower side or lower portion and may provide an RF signal 1523 for cellular communication to a second cellular transmission antenna disposed on one side of the upper side or upper portion, based on satisfaction of a transmission antenna change condition in cellular communication. Before the antenna change condition, e.g., the RF path corresponding to the first cellular transmission antenna may be activated, and the RF path corresponding to the second cellular transmission antenna may be deactivated. Meanwhile, the electronic device 101 may deactivate 1522 an RF path corresponding to a first Bluetooth transmission antenna disposed on another side of the lower side or lower portion and may apply an RF signal 1524 to a second Bluetooth transmission antenna disposed on another side of the upper side or upper portion. According to the transmission antenna change in cellular communication, a case may occur where both cellular communication and Bluetooth communication are allocated to the second antenna group.

In this case, the electronic device 101 may allocate Bluetooth communication to the first antenna group. The electronic device 101 may provide an RF signal 1532 to the first Bluetooth transmission antenna and may deactivate 1534 an RF path corresponding to the second Bluetooth transmission antenna. Accordingly, in the first antenna group, the RF path corresponding to the first cellular transmission antenna may be deactivated 1531, and an RF signal 1532 may be provided only to the first Bluetooth transmission antenna. In the second antenna group, the RF path corresponding to the second Bluetooth transmission antenna may be deactivated 1534, and an RF signal 1533 may be applied only to the second cellular transmission antenna. One communication may be allocated to each of both antenna groups. Meanwhile, in an embodiment, those skilled in the art will understand that Wi-Fi communication (which may be, e.g., 5 GHz, but there is no limitation) may operate together with Bluetooth communication instead of cellular communication. For example, the electronic device 101 may be configured to allocate the first Bluetooth communication to the first antenna group when the SAR cumulative value previously generated in the first antenna group is relatively small (e.g., when it is smaller than a threshold cumulative value).

According to an embodiment, the electronic device 101 may include at least one communication processor 501 and at least one short-range communication module 533. The at least one communication processor 501 may be configured to control a first RF signal for cellular communication to be provided to a first antenna. The at least one short-range communication module 533 may be configured to control a second RF signal for non-cellular communication to be provided to a second antenna included in a first antenna group including the first antenna. The at least one communication processor 501 may be configured to determine that a third RF signal for non-cellular communication is provided to a third antenna included in a second antenna group different from the first antenna group, based on identifying that a SAR cumulative value corresponding to the first antenna group satisfies a designated condition. The at least one communication processor 501 may be configured to provide the at least one short-range communication module 533 with a control signal causing the third RF signal for the non-cellular communication to be provided to the third antenna. The short-range communication module may be configured to control the third RF signal for the non-cellular communication to be provided to the third antenna, based on receiving the control signal.

According to an embodiment, the at least one communication processor 501 may, as at least a portion of identifying that the SAR cumulative value corresponding to the first antenna group satisfies the designated condition, identify that the SAR cumulative value corresponding to the first antenna group is equal to or greater than a first threshold cumulative value, as satisfaction of the designated condition.

According to an embodiment, the at least one communication processor 501 may be configured to, as at least a portion of identifying that the SAR cumulative value corresponding to the first antenna group satisfies the designated condition, identify that the SAR cumulative value corresponding to the first antenna group satisfies a designated back-off condition, as satisfaction of the designated condition.

According to an embodiment, the at least one communication processor 501 may be further configured to back off a maximum transmission power value for cellular communication, based on the SAR cumulative value corresponding to the first antenna group satisfying the designated back-off condition.

According to an embodiment, the at least one short-range communication module 533 may be configured to, as at least a portion of controlling the second RF signal for the non-cellular communication to be provided to the second antenna included in the first antenna group including the first antenna, perform a 2TX operation so that the second RF signal is provided to the second antenna while a fourth RF signal is provided to a third antenna included in the second antenna group.

According to an embodiment, the at least one short-range communication module 533 may be configured to, as at least a portion of controlling the third RF signal for the non-cellular communication to be provided to the third antenna based on receiving the control signal, perform a 1TX operation so that the third RF signal is provided to the third antenna.

According to an embodiment, a maximum value of transmission power corresponding to the 2TX operation may be smaller than a maximum value of transmission power corresponding to the 1TX operation.

According to an embodiment, the at least one communication processor 501 may be configured to, as at least a portion of determining that the third RF signal for the non-cellular communication is to be provided to the third antenna included in the second antenna group different from the first antenna group, determine that the third RF signal for the non-cellular communication is provided to the third antenna included in the second antenna group different from the first antenna group, based on at least one additional condition being satisfied, the at least one additional condition including that a SAR cumulative value previously generated in the second antenna group is equal to or less than a second threshold cumulative value, and/or that the cellular communication is not allocated to the second antenna group.

According to an embodiment, the at least one short-range communication module 533 may be configured to, as at least a portion of controlling the second RF signal for the non-cellular communication to be provided to the second antenna included in the first antenna group including the first antenna, perform a 1TX operation so that the second RF signal is provided to the second antenna included in the first antenna group including the first antenna.

According to an embodiment, the at least one communication processor 501 may be configured to, as at least a portion of determining that the third RF signal for the non-cellular communication is to be provided to the third antenna included in the second antenna group different from the first antenna group, based on identifying that the SAR cumulative value corresponding to the first antenna group satisfies the designated condition, determine to perform a 2TX operation in which the third RF signal for the non-cellular communication is provided to the third antenna and a fifth RF signal for the non-cellular communication is provided to the second antenna. The at least one communication processor 501 may be configured to, as at least a portion of providing the at least one short-range communication module 533 with the control signal causing the third RF signal for the non-cellular communication to be provided to the third antenna, provide the at least one short-range communication module 533 with the control signal causing execution of the 2TX operation in which the third RF signal for the non-cellular communication is provided to the third antenna and the fifth RF signal for the non-cellular communication is provided to the second antenna.

According to an embodiment, the short-range communication module may be configured to, as at least a portion of controlling the third RF signal for the non-cellular communication to be provided to the third antenna based on receiving the control signal, perform the 2TX operation in which the third RF signal for the non-cellular communication is provided to the third antenna and the fifth RF signal for the non-cellular communication is provided to the second antenna, based on receiving the control signal.

According to an embodiment, a maximum value of transmission power corresponding to the 2TX operation may be smaller than a maximum value of transmission power corresponding to the 1TX operation.

According to an embodiment, the at least one communication processor 501 may be configured to, as at least a portion of determining to perform the 2TX operation in which the third RF signal for the non-cellular communication is provided to the third antenna and the fifth RF signal for the non-cellular communication is provided to the second antenna, determine to perform the 2TX operation based on at least one additional condition being satisfied, the at least one additional condition including that a SAR cumulative value previously generated in the second antenna group is less than a second threshold cumulative value, and/or that the cellular communication is allocated to the second antenna group.

A method for operating the electronic device 101 according to an embodiment may include controlling, by the at least one communication processor 501 of the electronic device 101, a first RF signal for cellular communication to be provided to a first antenna. The method for operating the electronic device 101 may include controlling, by the at least one short-range communication module 533, a second RF signal for non-cellular communication to be provided to a second antenna included in a first antenna group including the first antenna. The method for operating the electronic device 101 may include determining, by the at least one communication processor 501, that a third RF signal for non-cellular communication is to be provided to a third antenna included in a second antenna group different from the first antenna group, based on identifying that a SAR cumulative value corresponding to the first antenna group satisfies a designated condition. The method for operating the electronic device 101 may include providing, by the at least one communication processor 501, the at least one short-range communication module 533 with a control signal causing the third RF signal for the non-cellular communication to be provided to the third antenna. The method for operating the electronic device 101 may include controlling, by the short-range communication module, the third RF signal for the non-cellular communication to be provided to the third antenna, based on receiving the control signal.

According to an embodiment, a storage medium storing computer-readable instructions, wherein the instructions, when executed by at least one processor of the electronic device 101, may cause the electronic device 101 to identify, for a first antenna group of the electronic device 101, a first SAR cumulative value based on cellular communication and a second SAR cumulative value based on non-cellular communication. The instructions, when executed by at least one processor of the electronic device 101, may cause the electronic device 101 to identify that the first SAR cumulative value and the second SAR cumulative value satisfy a designated condition. The instructions, when executed by at least one processor of the electronic device 101, may cause the electronic device 101 to allocate either the cellular communication or the non-cellular communication to a second antenna group, based on satisfaction of the designated condition.

According to an embodiment, identifying that the first SAR cumulative value and the second SAR cumulative value satisfy the designated condition may identify that the first SAR cumulative value and the second SAR cumulative value are equal to or greater than a first threshold cumulative value, as satisfaction of the designated condition.

According to an embodiment, identifying that the first SAR cumulative value and the second SAR cumulative value satisfy the designated condition may identify that the first SAR cumulative value and the second SAR cumulative value satisfy a designated back-off condition, as satisfaction of the designated condition.

According to an embodiment, allocating either the cellular communication or the non-cellular communication to the second antenna group based on satisfaction of the designated condition may determine to perform a 1TX operation using the second antenna group instead of a 2TX operation using the first antenna group and the second antenna group for the non-cellular communication, based on satisfaction of the designated condition.

According to an embodiment, allocating either the cellular communication or the non-cellular communication to the second antenna group based on satisfaction of the designated condition may determine to perform a 2TX operation using the first antenna group and the second antenna group instead of a 1TX operation using the first antenna group for the non-cellular communication, based on satisfaction of the designated condition.

According to an embodiment, a maximum value of transmission power corresponding to the 2TX operation may be smaller than a maximum value of transmission power corresponding to the 1TX operation.

According to an embodiment, the electronic device 101 may include at least one communication processor 501 and at least one short-range communication module 533. The at least one communication processor 501 may be configured to control a first RF signal for cellular communication to be provided to a first antenna. The at least one communication processor 501 may be configured to identify an activation event of non-cellular communication. The at least one communication processor 501 may be configured to identify to use a second antenna included in a second antenna group different from a first antenna group including the first antenna, for the non-cellular communication, based on identifying the activation event. The at least one communication processor 501 may be configured to provide the at least one short-range communication module 533 with a control signal causing use of the second antenna. The at least one short-range communication module 533, comprising communication circuitry, may be configured to control a second RF signal for the non-cellular communication to be provided to the second antenna included in the second antenna group, based on receiving the control signal.

According to an embodiment, a method for operating the electronic device 101 may include controlling, by the at least one communication processor 501, a first RF signal for cellular communication to be provided to a first antenna. The method for operating the electronic device 101 may include identifying, by the at least one communication processor 501, an activation event of non-cellular communication. The method for operating the electronic device 101 may include identifying, by the at least one communication processor 501, to use a second antenna included in a second antenna group different from a first antenna group including the first antenna, for the non-cellular communication, based on identifying the activation event. The method for operating the electronic device 101 may include providing, by the at least one communication processor 501, the at least one short-range communication module 533 with a control signal causing use of the second antenna. The method for operating the electronic device 101 may include controlling, by the at least one short-range communication module 533, a second RF signal for the non-cellular communication to be provided to the second antenna included in the second antenna group, based on receiving the control signal.

According to an embodiment, in a storage medium storing computer-readable instructions, the instructions may, when executed by at least one processor of the electronic device 101, cause the electronic device 101 to allocate cellular communication to a first antenna group of the electronic device 101. The instructions may, when executed by at least one processor of the electronic device 101, cause the electronic device 101 to identify an activation event of non-cellular communication. The instructions may, when executed by at least one processor of the electronic device 101, cause the electronic device 101 to allocate the non-cellular communication to a second antenna group different from the first antenna group, based on identifying the activation event.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
at least one communication processor comprising processing circuitry; and
at least one short-range communication module comprising circuitry,
wherein the at least one communication processor is configured, individually and/or collectively, to control a first RF signal for cellular communication to be provided to a first antenna,
wherein the at least one short-range communication module is configured, individually and/or collectively, to control a second RF signal for non-cellular communication to be provided to a second antenna included in a first antenna group including the first antenna,
wherein the at least one communication processor is configured, individually and/or collectively, to:
determine that a third RF signal for non-cellular communication is provided to a third antenna included in a second antenna group different from the first antenna group, based on identifying that a SAR cumulative value corresponding to the first antenna group satisfies a designated condition, and
provide the at least one short-range communication module with a control signal for causing the third RF signal for the non-cellular communication to be provided to the third antenna, and
wherein the at least one short-range communication module is individually and/or collectively configured to control the third RF signal for the non-cellular communication to be provided to the third antenna, based on receiving the control signal.

2. The electronic device of claim 1, wherein the at least one communication processor is individually and/or collectively configured to, as at least a portion of identifying that the SAR cumulative value corresponding to the first antenna group satisfies the designated condition, identify that the SAR cumulative value corresponding to the first antenna group is equal to or greater than a first threshold cumulative value, as satisfaction of the designated condition.

3. The electronic device of claim 1, wherein the at least one communication processor is individually and/or collectively configured to, as at least a portion of identifying that the SAR cumulative value corresponding to the first antenna group satisfies the designated condition, identify that the SAR cumulative value corresponding to the first antenna group satisfies a designated back-off condition, as satisfaction of the designated condition.

4. The electronic device of claim 1, wherein the at least one communication processor is individually and/or collectively configured to back off a maximum transmission power value for cellular communication, based on the SAR cumulative value corresponding to the first antenna group satisfying the designated back-off condition.

5. The electronic device of claim 1, wherein the at least one short-range communication module is individually and/or collectively configured to, as at least a portion of controlling the second RF signal for the non-cellular communication to be provided to the second antenna included in the first antenna group including the first antenna, initiate a 2TX operation so that the second RF signal is provided to the second antenna while a fourth RF signal is provided to a third antenna included in the second antenna group.

6. The electronic device of claim 5, wherein the at least one short-range communication module is individually and/or collectively configured to, as at least a portion of controlling the third RF signal for the non-cellular communication to be provided to the third antenna based on receiving the control signal, initiate a 1TX operation so that the third RF signal is provided to the third antenna.

7. The electronic device of claim 6, wherein a maximum value of transmission power corresponding to the 2TX operation is smaller than a maximum value of transmission power corresponding to the 1TX operation.

8. The electronic device of claim 1, wherein the at least one communication processor is individually and/or collectively configured to, as at least a portion of determining that the third RF signal for the non-cellular communication is provided to the third antenna included in the second antenna group different from the first antenna group, determine that the third RF signal for the non-cellular communication is provided to the third antenna included in the second antenna group different from the first antenna group, based on at least one additional condition being satisfied, the at least one additional condition including that a SAR cumulative value previously generated in the second antenna group is equal to or less than a second threshold cumulative value, and/or that the cellular communication is not allocated to the second antenna group.

9. The electronic device of claim 1, wherein the at least one short-range communication module is individually and/or collectively configured to, as at least a portion of controlling the second RF signal for the non-cellular communication to be provided to the second antenna included in the first antenna group including the first antenna, initiate a 1TX operation so that the second RF signal is provided to the second antenna included in the first antenna group including the first antenna.

10. The electronic device of claim 1, wherein the at least one communication processor is individually and/or collectively configured to, as at least a portion of determining that the third RF signal for the non-cellular communication is provided to the third antenna included in the second antenna group different from the first antenna group, based on identifying that the SAR cumulative value corresponding to the first antenna group satisfies the designated condition, determine to perform a 2TX operation in which the third RF signal for the non-cellular communication is provided to the third antenna and a fifth RF signal for the non-cellular communication is provided to the second antenna, and the at least one communication processor is individually and/or collectively configured to, as at least a portion of providing the at least one short-range communication module with the control signal causing the third RF signal for the non-cellular communication to be provided to the third antenna, provide the at least one short-range communication module with the control signal causing execution of the 2TX operation in which the third RF signal for the non-cellular communication is provided to the third antenna and the fifth RF signal for the non-cellular communication is provided to the second antenna.

11. The electronic device of claim 10, wherein the short-range communication module is individually and/or collectively configured to, as at least a portion of controlling the third RF signal for the non-cellular communication to be provided to the third antenna based on receiving the control signal, perform the 2TX operation in which the third RF signal for the non-cellular communication is provided to the third antenna and the fifth RF signal for the non-cellular communication is provided to the second antenna, based on receiving the control signal.

12. The electronic device of claim 10, wherein a maximum value of transmission power corresponding to the 2TX operation is smaller than a maximum value of transmission power corresponding to a 1TX operation.

13. The electronic device of claim 10, wherein the at least one communication processor is individually and/or collectively configured to, as at least a portion of determining to perform the 2TX operation in which the third RF signal for the non-cellular communication is provided to the third antenna and the fifth RF signal for the non-cellular communication is provided to the second antenna, determine to perform the 2TX operation based on at least one additional condition being satisfied, the at least one additional condition including that a SAR cumulative value previously generated in the second antenna group is less than a second threshold cumulative value, and/or that the cellular communication is allocated to the second antenna group.

14. A storage medium storing computer-readable instructions, the at least one instruction, when executed individually and/or collectively by at least one processor of an electronic device, causing the electronic device to perform steps comprising:
identifying, for a first antenna group of the electronic device, a first SAR cumulative value based on cellular communication and a second SAR cumulative value based on non-cellular communication;
identifying that the first SAR cumulative value and the second SAR cumulative value satisfy a designated condition; and
allocate either the cellular communication or the non-cellular communication to a second antenna group, based on satisfaction of the designated condition.

15. An electronic device comprising:
at least one communication processor comprising processing circuitry; and
at least one short-range communication module comprising processing circuitry,
wherein the at least one communication processor is individually and/or collectively configured to:
control a first RF signal for cellular communication to be provided to a first antenna;
identify an activation event of non-cellular communication;
identify to use a second antenna included in a second antenna group different from a first antenna group including the first antenna, for the non-cellular communication, based on identifying the activation event; and
provide the at least one short-range communication module with a control signal causing use of the second antenna, and
wherein the at least one short-range communication module is individually and/or collectively configured to control a second RF signal for the non-cellular communication to be provided to the second antenna included in the second antenna group, based on receiving the control signal.
